(19) United States
(12) Patent Application Publication
(10) Pub. No.: US 2025/0059476 A1
(43) Pub. Date: Feb. 20, 2025

(54) FOAMED UTENSILS COMPRISING NANOCELLULOSE ELEMENTS

(71) Applicant: SOANE MATERIALS LLC, Miami, FL (US)

(72) Inventors: David S. SOANE, Coral Gables, FL (US); Delilah M. LUBARSKY, Miami, FL (US); Lauren G. DUKE, Miami, FL (US); Sydney Greenough HIGGINS, Miami, FL (US); Alexander V. SOANE, Coral Gables, FL (US)

(21) Appl. No.: 18/807,203

(22) Filed: Aug. 16, 2024

Related U.S. Application Data
(60) Provisional application No. 63/533,309, filed on Aug. 17, 2023.

(51) Int. Cl. C11D 17/04; C08J 5/18; C08J 9/00; C08J 9/28

(52) U.S. Cl. CPC C11D 17/049; C08J 5/18; C08J 9/0085; C08J 9/28; C11D 17/047; C08J 2207/12; C08J 2301/02; C08J 2401/02

(57) ABSTRACT

The present invention includes surface-interactive utensils comprising a foamed material that includes a simple nanocellulose element (NCE)-based matrix comprising redispersed or redispersible NCEs or a composite NCE-containing matrix comprising redispersed or redispersible NCEs. The invention also includes methods of manufacturing such utensils.

### RELATED APPLICATION

This application claims the benefit of U.S. Provisional Application 63/533,309, filed Aug. 17, 2023. The entire contents of the above application are incorporated by reference herein.

### FIELD OF THE INVENTION

This application relates to formulations comprising nanocellulosic materials for use in forming foamed utensils for delivery of active agents to target surfaces.

### BACKGROUND OF THE INVENTION

Conventional utensils that interact with target surfaces typically possess specific properties that enable them to complete their intended tasks. Such tasks can involve activities such as cleaning a surface, ameliorating a surface, altering the properties of a surface, and the like. Useful properties in such utensils include absorbency, durability, tunable abrasiveness, and a convenient ergonomic form factor. In addition, since the utensil is commonly used with a specific active agent, e.g., for a cleaning utensil, soap or other cleaning substances, the utensil needs to be compatible with the selected active agent and capable of delivering the active agent to the surface with which it will interact.

Such utensils are often employed for cleaning purposes, whether for household purposes or for personal/pet care. Furthermore, since these utensils are employed for cleaning purposes, they need to be themselves easy to clean, hygienic to store, and resistant to bacterial growth, odor formation, or cross-contamination. In general, the desired attributes of a cleaning utensil depend on its intended use, the surface being cleaned, and the types of contaminants that are to be removed from that surface.

A variety of synthetic materials have been employed to provide conventional cleaning utensils with these desirable features. Cleaning pads and sponges can be made from synthetic plastics such as polyurethane and polyethylene. Scrubbing pads can incorporate a variety of synthetic plastics depending on their intended uses. Plastic scrubbing sponges can be formed from combinations of synthetic plastics. Stain-removing abrasive utensils such as the Magic Eraser are made from melamine foam. Most conventional cleaning wipes are made from materials such as polyester (polyethylene terephthalate) or polypropylene. Synthetic materials for cleaning utensils have offered an attractive combination of durability, abrasion resistance, water resistance, and adaptability, allowing such utensils to be formed economically and in appropriate shapes and sizes.

As environmental awareness has increased however, more attention has been focused on the lifecycle of surface-interactive utensils such as cleaning utensils, and the methods available for disposing of them at the end of their useful lives. Utensils made from conventional, petroleum-derived plastics are not biodegradable and are typically relegated to landfills for disposal. These articles, once they reach a landfill, can take 450-1000 years—or more—to break down, yielding microplastic particles as they decompose. It has been estimated that several hundred million household sponges are discarded each year in the US alone, many of which incorporate non-biodegradable plastics that are not easily recycled. Moreover, such cleaning utensils can be disposed of improperly, and undergo their lengthy decomposition in areas such as waterways, beaches, and alongside roadways, where they can become ingested aquatic or terrestrial animals in those local environments.

Concerns about the environmental impact of discarded and decomposing plastic articles have spurred manufacturers to consider bio-based alternatives. Materials composed in whole or in significant part of biological products or renewable agricultural materials or forestry materials, have been designated as “bio-based” by the USDA. Biopolymers derived from bio-based materials can be used to form bioplastic materials that offer alternatives to conventional, petroleum-derived plastics.

Biopolymers can be produced by biological systems (microorganisms, plants, animals) or chemically synthesized from biological materials such as proteins, starches, and sugars. The primary sources of biopolymers are renewable, such as agricultural feedstocks or waste products. Many biopolymers are biodegradable, which means that they are capable of decomposing into carbon dioxide, water, and other organic compounds via the enzymatic actions of microorganisms. Those bio-based plastics made from precursors such as polylactic acid (PLA), polyhydroxyalkanoates (PHAs), and cellulose are considered biodegradable, in that they can be decomposed in the environment by microorganisms. Certain biodegradable materials are further deemed “compostable,” meaning that they can be degraded by microorganisms to form nutrient-rich organic material that is able to enrich the soil, yielding final products that are similar to those produced during natural composting.

While these bio-based plastic alternatives, such as bio-derived or cellulose-based plastics, are of great interest as substrates for manufacturing cleaning utensils, their use remains limited, in part due to performance limitations. As an example, sponges and similar cleaning utensils made from cellulose may have some performance limitations compared to synthetic or mixed material sponges. Cellulose sponges typically have good absorption properties, but may not be as absorbent as synthetic sponges, which leads to a lower ability to hold and retain liquids during the cleaning process. Cellulose sponges are also typically less durable than their synthetic counterparts. They may wear out more quickly and they may be less suited for heavy-duty tasks. Cellulose sponges without modifications are typically less abrasive than scrubbing pads or sponges made from synthetic materials, which again can render them less suitable for heavy-duty tasks.

To address these limitations, manufacturers have added inorganic and organic materials to bio-based formulations in order to improve their mechanical properties and streamline their processing. Compared to those materials using inorganic additives, bioplastics that incorporate natural particles or fibers can offer advantages of renewability, high strength, relatively easy processing, and other desirable properties. Nanoscale and microscale cellulosic fibers, such as nanofibrillated celluloses (NFCs), microfibrillated celluloses (MFCs), and nanocrystalline celluloses (NCCs) are particularly attractive fillers for improving absorbency, strength, and overall cleaning effectiveness in utensils made from bio-based material. In cellulose-based sponge materials, for example, NFCs, MFCs, and/or NCCs (collectively termed “nanocellulose elements,” “NC elements,” or “NCEs”) can make the sponge more durable and efficient at absorbing and retaining liquids. In cleaning pads, these NCEs can be used as reinforcing agents to enhance strength, abrasion resistance, and durability, permitting more effective scrubbing and cleaning. They can also be used in composite cleaning utensils to improve mechanical properties, absorbency and moisture management, and scrubbing capabilities (e.g., strengthening/stiffening fibers on the scrubbing side of the composite utensil, thereby creating an abrasive surface to enhance cleaning), leading to overall enhanced performance.

While NCEs hold promise for use in biopolymeric cleaning utensils, there are restrictions. First of all, the NCE fibers themselves are hydrophilic, and thus do not contribute to the water resistance of a formed product. This is of particular importance for a cleaning utensil that is intended to be wetted for use. Without adequate water resistance, the utensil itself can become soggy and hard to manipulate when saturated with water.

More importantly, the NCEs need to be transported to where they will be used in highly diluted suspensions (<5-10 wt %) to prevent them from becoming entangled with each other. This entangling can lead to their consolidation into a dense, viscous mass that resists redispersion; if this tight network of aggregated cellulosic elements is further dewatered, it solidifies further, a process termed hornification. With complete drying of the NCE suspension, a solid bricklike mass is formed that is substantially undispersable. Therefore, in order to maintain a NCE suspension in a usable state so that the properties of the NCEs it contains are accessible for use in other materials, it must be maintained in a highly diluted form.

Despite a decade-long series of academic and industrial efforts, success in low-cost and effective drying and redispersion of NCEs has eluded nanocellulose producers. The twin challenges of (a) drying the aqueous media in which the NCEs are suspended and (b) redispersion of the dried NCEs are caused by two factors: (1) the propensity of cellulose polymers in the NCEs to form hydrogen bonds with one another, adhering adjacent cellulosic elements into irreversible aggregates comprised of an assemblage of particles durably attached to each other, resisting redispersion in a suspension; and (2) the huge surface area per unit weight associated with the size and morphology of the NCE, greatly increasing exposure of the NCE surfaces to each other and exacerbating adhesion due to hydrogen bonding. The tendency towards hornification in NCE suspensions requires that these substances be transported in a high volume of water, adding significantly to the costs associated with their use. Further, if a highly dilute NCE-containing suspension is used to form a foam, for example for use in a sponge or a cleaning pad, the excess water becomes incorporated in the foam and must be removed by a drying technique that permits NCEs to be dispersed evenly within the foam-forming matrix. While drying techniques such as freeze drying, spray drying, supercritical fluid drying and atomization, and the like, have been investigated by researchers, they have at best yielded small samples of redispersed NC elements, using processes whose high cost, energy requirements, and need for specialized equipment preclude their widespread adoption.

There remains a need in the art, therefore, for methods and formulations that afford bio-based foam-based articles of manufacture a satisfactory degree of mechanical strength and water/oil resistance to provide commercially viable alternatives to petroleum-derived plastics for foamed articles of manufacture. To the extent that NCEs are to be integrated into bio-based foam-forming materials for such articles, there is a need to allow their commercial implementation at low cost, without excessive energy requirements, and without need for specialized equipment. To accomplish this latter goal, there remains an unmet need to render nanocellulose-containing formulations redispersible and resistant to hornification, so that these formulations can be transported economically and introduced into bio-based, foam-forming composites as a concentrate or as a dried particulate additive.

### SUMMARY OF THE INVENTION

Disclosed herein, in embodiments, are cleaning utensils, comprising a foamed material, wherein the foamed material comprises a simple NCE-based matrix comprising redispersed NCEs, or a composite NCE-containing matrix comprising redispersed NCEs, wherein the foamed material is shaped in a form suitable for use with a cleaning substance. In embodiments, the foamed material is shaped as a sponge, which can have buoyant properties. In embodiments the foamed material encloses an inner deposit of the cleaning substance, which can be surrounded by a membrane that is at least one of (a) semipermeable to water or (b) partially or fully dissolvable in water. In embodiments, the foamed material further comprises a water-resistant barrier formulation, wherein the water-resistant barrier formulation at least partially restricts subsequent redispersibility of the redispersed NCEs. In embodiments, the foamed material further comprises an external layer of a cleaning substance or of a scrubbing material having different mechanical properties than the formed article.

Further disclosed herein, in embodiments, are cleaning utensils comprising a cleaning formulation comprising a cleaning agent and a population of redispersible NCEs formulated with one or more dispersal additives; and a foamed material, wherein the cleaning formulation is included within the cells of the foamed material or coated around the outside of the foamed material, or both, and wherein the foamed material comprises a simple NCE-based matrix comprising a population of redispersed NCEs or a composite NCE-containing matrix comprising the population of redispersed NCEs, wherein subsequent redispersibility of the redispersed NCEs is restricted. In embodiments, the cleaning formulation comprises the population of redispersible NCEs formulated with one or more dispersal additives; and a task-specific cleaning agent. In embodiments, the dispersal additives can comprise xylitol and hydroxypropylmethyl cellulose (HPMC), with NCEs, HPMC and xylitol present in a ratio of between about 5:2:10 (NCE:HPMC:xylitol) to about 6:1:1 (NCE:HPMC:xylitol). The cleaning formulation can further comprise one or more additives selected from the group consisting of a foaming agent, an additive to manage water hardness, an antimicrobial agent, a secondary cleaning substance, a colorant, and a fragrance. In embodiments, the cleaning formulation is imbibed into the foamed material. In embodiments, the cleaning formulation at least partially encases the foamed material. In embodiments, the foamed material can further comprise at least one of a reinforcement agent and a barrier formulation, or both the reinforcement agent and the barrier formulation. The reinforcement agent can comprise an additional amount of NCEs. The barrier formulation can produce at least one of hydrophobicity and olcophobicity. In an embodiment, the barrier formulation produces oleophobicity and comprises methylcellulose. Also disclosed herein are methods of manufacturing a cleaning utensil, comprising

providing a foamed material comprising redispersed NCEs, wherein the foamed material comprises a simple NCE-based matrix comprising redispersed NCEs or a composite NCE-containing matrix comprising redispersed NCEs; fully drying the foamed material to form a dried formed foamed article; exposing the dried formed foamed article to a cleaning substance, so that the formed foamed article either imbibes the cleaning substance into its interior or becomes at least partially encased in the cleaning substance, thereby forming a cleaning-substance-bearing foamed article; and drying the cleaning-substance-bearing foamed article to produce the cleaning utensil. In embodiments, the cleaning substance comprises a conventional cleaning agent or formulation. In embodiments, the cleaning substance is formulated as a NCE-containing cleaning formulation comprising a population of redispersible NCEs formulated with one or more dispersal additives; and a task-specific cleaning agent. In embodiments, the dispersal additives can comprise xylitol and hydroxypropylmethyl cellulose (HPMC), with NCEs, HPMC and xylitol present in a ratio of between about 5:2:10 (NCE:HPMC:xylitol) to about 6:1:1 (NCE:HPMC:xylitol). In embodiments, the NCE-containing cleaning formulation further comprises one or more additives selected from the group consisting of a foaming agent, an additive to manage water hardness, an antimicrobial agent, a secondary cleaning substance, a colorant, and a fragrance. In embodiments, the method further comprises a step selected from the group consisting of (a) encasing the foamed material in an external layer of a scrubbing material before the step of drying the foamed material to form the dried formed foamed article, wherein the scrubbing material has different mechanical properties than the dried formed foamed article; and (b) encasing the foamed article bearing the cleaning substance in the scrubbing material before the step of drying the cleaning-substance-bearing foamed article to produce the cleaning utensil, wherein the scrubbing material has different properties than the cleaning-substance-bearing foamed article.

Also disclosed herein are surface-interactive utensils comprising a foamed material, wherein the foamed material comprises a simple NCE-based matrix comprising redispersed or redispersible NCEs or a composite NCE-containing matrix comprising redispersed or redispersible NCEs. In embodiments, the surface-interactive utensil further comprises an active agent and the foamed material is amalgamated with active agent. In certain aspects, the foamed material is amalgamated with the active agent by a mechanism selected from the group consisting of coating a portion of the foamed material with the active agent, enveloping the active agent in the foamed material, or layering the foamed material to deploy the active agent on a layer that is interdigitated with other components of the surface-interactive utensil. In embodiments, the surface-interactive utensil is intended for multiple uses and/or the surface-interactive utensil is multipurpose. In further aspects, the surface-interactive utensil comprises a durable component and a dissolvable component. In embodiments, the surface-interactive utensil is a cleaning utensil, and the active agent comprises a cleaning substance. Such cleaning utensils can be dimensionally and functionally adapted for carrying out a cleaning task for personal care purposes. In embodiments, the foamed material is shaped as a sponge. In embodiments, the foamed material can be surrounded by a layer of the active agent, or the foamed material encloses an inner deposit of the active agent, wherein the inner deposit can be surrounded by a membrane that is at least one of (a) semipermeable to water or (b) partially or fully dissolvable in water. In embodiments, the foamed material comprises the simple NCE-based matrix, which can comprise redispersible NCEs. In other embodiments, the foamed material comprises the composite NCE-containing matrix, which can comprise redispersed NCEs. In embodiments, the foamed material further comprises an external layer comprising the active agent or comprising a scrubbing material having different mechanical properties than the foamed material.

Further disclosed herein, in embodiments, are surface-interactive utensils, comprising a surface-interactive foamed material selected from the group consisting of an absorbent material, an abrasive material, and an applicator material, and further comprising an active agent, wherein the surface-interactive foamed material comprises a simple NCE-based matrix comprising a population of redispersed or redispersible NCEs or comprises a composite NCE-containing matrix comprising the population of redispersed or redispersible NCEs; and wherein the active agent is included within the cells of the foamed material or coated around at least a portion of the outside of the foamed material, or both. In embodiments, such a surface-interactive utensil can have a shape that is flat, curved, pointed, rectangular, cuboidal, conical, cylindrical, spherical, and toroidal, and a size three-dimensionally that is adapted for directing the active agent to the target surface and permitting the manipulation necessary to reach the target surface and direct the active agent thereto. In embodiments, the surface-interactive utensil is shaped to facilitate hand-held use or to reach into narrow apertures. In embodiments, the surface-interactive utensil is dimensionally adapted to come into close contact with a surface to impart a treatment to the surface or to deliver an active agent to the surface, or both. In embodiments, the foamed material is amalgamated with the active agent, for example, by a mechanism selected from the group consisting of incorporating the active agent into its substance, the active agent into its substance, coating a portion of the foamed material with the active agent, enveloping the active agent in the foamed material, or layering the foamed material to deploy the active agent on a layer that is interdigitated with other components of the utensil. In embodiments, the foamed material is constructed to have a limited lifespan. In embodiments, the active agent is selected from the group consisting of cleaning agents for household or personal care purposes, personal care agents, pharmaceutical or medicinal or wellness-promoting agents, cosmetic agents, and agricultural or horticultural agents. In embodiments, the surface-interactive utensil is a cleaning utensil, and the active agent is a cleaning agent for household or personal care purposes. In embodiments, the cleaning agent comprises NCEs, and the cleaning agent can comprise NCEs and HPMC and xylitol in a ratio of between about 5:2:10 (NCE:HPMC:xylitol) to about 6:1:1 (NCE:HPMC:xylitol). In embodiments, the cleaning agent is imbibed into the foamed material or the cleaning agent at least partially encases the foamed material. In embodiments, one or more additives selected from the group consisting of a foaming agent, an additive to manage water hardness, an antimicrobial agent, a secondary cleaning substance, a colorant, and a fragrance, are combined with the cleaning agent to produce a cleaning formulation. In embodiments, the foamed material further comprises a reinforcement agent, which can comprise NCEs. In embodiments, the foamed material further comprises a barrier formulation, which can produce at least one of hydrophobicity and oleophobicity. In embodiments, the active agent is coated on at least a portion of the outside of the foamed material in layers.

Also disclosed herein are methods of manufacturing a surface-interactive utensil, comprising providing a foamed material, wherein the foamed material comprises a simple NCE-based matrix comprising redispersed or redispersible NCEs or a composite NCE-containing matrix comprising redispersed or redispersible NCEs; initially drying the foamed material to form a dried formed foamed article; exposing the dried formed foamed article to an active agent so that the formed foamed article either imbibes the active agent into its interior or becomes at least partially encased in the active agent, thereby forming an active-agent-bearing foamed article; and secondarily drying the active-agent-bearing foamed article to produce the surface-interactive utensil. In embodiments, the surface-interactive utensil is a cleaning utensil and the active agent comprises a cleaning substance, which can be a cleaning agent or a cleaning formulation, wherein the cleaning agent can be a conventional cleaning agent. In embodiments, the method further comprises a step selected from the group consisting of encasing the foamed material in an external layer of a scrubbing material before the step of initially drying the foamed material, wherein the scrubbing material has different mechanical properties than the dried formed foamed article wherein the scrubbing material has different mechanical properties than the dried formed foamed article; and encasing the foamed article bearing the cleaning substance in the scrubbing material before the step of secondarily drying the cleaning-substance-bearing foamed article, wherein the scrubbing material has different mechanical properties than the cleaning-substance-bearing foamed article.

In certain aspects, the redispersible NCEs (e.g., in the simple NCE-based matrix or the composite NCE-based matrix as described herein) are prepared by partially or completely drying a liquid formulation, wherein the liquid formulation comprises a suspension of nanocellulose elements (NCEs) in a liquid medium and a drying/dispersal additive. In additional aspects, the redispersed NCEs are prepared by suspending the redispersible NCEs in a resuspending fluid. The “drying/dispersal additive” can, for example, be a temperature-responsive polymer, a volatile small molecule additive or a blocking agent, and wherein the drying/dispersal additive disrupts hydrogen bonding between the nanocellulose elements during the drying of the liquid formulation.

In certain aspects, the surface-interactive utensil described herein comprises the drying/dispersal additive (for example, a temperature-responsive polymer, a volatile small molecule additive or a blocking agent). An exemplary drying/dispersal additive is a temperature response polymer, such as an LCST polymer (e.g., methyl cellulose).

In certain additional aspects, the surface-interactive utensil described herein comprises a surfactant and/or foaming agent (e.g., capryl glucoside).

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing a process for producing matrices comprising redispersed nanocellulose elements.

FIG. 2 is a block diagram showing a process for producing matrices comprising

redispersed nanocellulose elements.

FIG. 3 is a block diagram showing a process for producing matrices comprising redispersed nanocellulose elements.

FIG. 4 is a block diagram showing a process for producing foamed materials comprising redispersed nanocellulose elements.

FIGS. 5A and 5B depict exemplary embodiments of surface-interactive utensils formed from foamed materials comprising redispersed nanocellulose elements.

### DETAILED DESCRIPTION OF THE INVENTION

As used herein, the words “a” and “an” are meant to include one or more unless otherwise specified.

### 1. Components of Redispersible Nanocellulose Elements Formulations

a. Redispersible Nanocellulose Elements Generally

It has been unexpectedly discovered that nanocellulose elements (NCEs) can be treated so that they can be redispersed in formulations for producing useful articles of manufacture, using formulations and methods as set forth herein and as set forth in U.S. Pat. App. Publication No. 20220412010A1 (U.S. patent application Ser. No. 17/834,521 filed Jun. 7, 2022; referred to herein as the '521 Application), the contents of which are incorporated by reference herein in their entirety. Using these inventive methods, formulations containing NCEs can be prepared that can be concentrated or partially or fully dried and then redispersed without hornification. Formulations comprising such redispersed NCEs can then be employed for producing foamed materials, which can then be used for the manufacture of useful articles. The formulations comprising the redispersed NCEs can themselves be dried and formed to produce articles of manufacture, or such formulations can be integrated into pre-existing matrices to form composites having improved properties vs. the pre-existing matrix itself or that have additional properties not present in the pre-existing matrix.

Substrates suitable for treatment with the systems and methods disclosed herein (i.e., NFCs and MFCs and NCCs, collectively NCEs) can be derived from all types of cellulosic raw materials, in particular from plant-derived cellulosic raw materials. Plant-derived cellulosic raw materials comprise lignocellulosic materials: lignocellulosic materials are comprised of cellulose polymers bound together with varying amounts of lignin. Lignocellulosic materials of all kinds are suitable for use according to these systems and methods; examples of suitable lignocellulose materials are provided in the '521 Application.

In embodiments, NCEs are conventionally produced from precursor lignocellulosic materials or other plant-derived cellulosic raw materials by a series of mechanical and/or chemical procedures performed in an aqueous medium, wherein the aqueous suspension loosens cellulose's interfibrillar hydrogen bonding to facilitate delamination, resulting in the formation of NCEs such as NFCs and MFCs. NFCs and MFCs are extracted from plant matter by different techniques from each other, so that their morphologies and properties are different. NFCs and MFCs can be distinguished from each other based on their size and shape: cellulose nanofibers are much smaller in diameter than cellulose microfibers and can be straight and rod-like, while cellulose microfibers are larger in diameter, more flexible, and more varied and irregular in appearance. While the literature cites a range of dimensions for NFCs and MFCs, NFCs fibers are nanoscale (for example, having a diameter between 4-20 nm), while MFCs can be much larger, though typically still having diameters in the nano-range, for example 20-100 nm or larger. After the NCEs have been formed from the precursor cellulosic material, the NCEs are dispersed in the aqueous medium at a low concentration (<5 wt %) because their high water-absorption capacity and tendency for hydrogen bonding cause them to form a highly viscous suspension even at low solid concentrations due to the hydrogen-bond-driven entangling of the high-aspect-ratio NC elements, as described above.

Additives have been discovered, as described in the '521 Application, that can be used to prepare NCEs so that they are redispersible after being formulated in solutions. Such additives are termed “drying/dispersal additives” herein. Without being bound by theory, these additives function to inhibit or disrupt that hydrogen bonding of the NCEs with each other at specific, usually elevated reaction temperatures, thus preventing consolidation and hornification, while retaining their high intrinsic hydrophilicity that allows facile redispersion in aqueous media. As used herein, the term “redispersion” and its grammatical derivatives and congeners refers to a process by which concentrated or partially or fully dried NCEs prepared to be redispersible as described herein are suspended in a fluid medium (whether aqueous or non-aqueous), termed a resuspending fluid, so that there is a substantially complete dissolution of the partially or fully dried or concentrated suspension of NCEs to release its NCE components as resuspended in the resuspending fluid (i.e., redispersed). In embodiments, aqueous resuspending fluids can be used; in other embodiments, non-aqueous resuspending fluids can be used, such as fluids having hydrophobic properties or amphiphilic properties. In embodiments, redispersion results in a suspension of the NCEs so that they form as individual NCEs or amorphous coalescences of individual NCEs having an aspect ratio of greater than about 10 (such individual NCEs or amorphous coalescences being referred to herein as “resuspended particles”). In embodiments, the resuspended particles have an aspect ratio between about 10 and about 300, or between about 10 and about 200. In embodiments, the resuspended particles have an aspect ratio between about 50 and about 150. In embodiments, the resuspended particles have an aspect ratio between about 25 and about 75. In other embodiments, the resuspended particles have an aspect ratio between about 75 and about 125.

These formulations and methods include several different categories of drying/dispersal additives: (1) certain temperature-responsive polymers that can introduce spacing between NC elements during drying, thus preventing their clumping; (2) certain volatile small molecules that can create space between NC elements during drying; and (3) certain nonvolatile small or large molecules or fibrous or particulate materials that hinder hydrogen bonding between or among NC elements during drying (“blocking agents”). Drying/dispersal additives comprise, without limitation, temperature-responsive polymers, small molecule additives in volatile systems, and blocking agents. All of these materials act to disrupt hydrogen bonding at elevated temperatures or under other circumstances, while creating gaps between or among the NC elements with further drying that will permit subsequent redispersion. As used herein, the term “drying” refers to a process whereby water or other liquids are vaporized or otherwise removed from an initial material such as a solution, suspension, or other solid-liquid mixture to convert the initial material into a processed material having a lower content of water or other liquids. The term “drying” can be applied to the process of producing a material that is partially or completely dried, containing any amount of residual water or other liquid in the processed material provided that the amount of such water or liquid in the processed material is less than the amount of such water or liquid in the initial material. A “dried” material can be in a solid, semi-solid, or liquid state, provided that the processed material in such a dried state contains less water or other solvent than the initial pre-dried state.

While certain additives (for example, certain LCST polymers, as described below) are suitable for use as single agents for facilitating drying and redispersion, other additives lend themselves for use as adjuvants in combination with a main drying/dispersal additive, either when administered into the initial NC suspension simultaneously with the main additive, or when administered as pre-treatment to the initial NC suspension or any precursor thereof before adding the main additive, or when administered as a post-treatment to the initial NC suspension following the addition of the main drying/dispersal additive.

b. Drying/Dispersal Additives

It is understood that the drying/dispersal additives disclosed herein can be introduced into the initial NCE-containing suspension individually or in combination to improve the drying process for the NCEs and to facilitate their redispersion. Drying/dispersal additives can also be used in combination with other agents that enhance their efficacy, even if those other agents are not effective as drying/dispersal additives when used alone; such agents, used in combination with the drying/dispersal additives to enhance their efficacy, are termed “adjuvants.” It is further understood that one or more of the drying/dispersal additives and/or adjuvants can act together in a synergistic manner. Moreover, combinations of the drying/dispersal additives can be introduced sequentially during the preparation of the initial NC suspension, and/or before, after, or during the processes that are employed to produce the initial NC suspension from a feedstock of cellulosic sources, with or without the addition of adjuvants. For example, non-polymeric additives can be added during the processes that are employed to produce the initial NC suspension from feedstock, but desirably are to be added after chemical pretreatment of the initial NCEs that are derived from the cellulosic or lignocellulosic precursor material.

i. Temperature-Responsive Polymers

In embodiments, certain temperature-responsive polymers can be employed to create space between the NC elements during drying, thereby preventing the NC elements from aggregating during the drying process. By preventing the dense aggregation and consolidation of the NCEs, the temperature-responsive polymer allows them to be redispersed upon contact with the resuspending fluid. Temperature-responsive polymers especially suitable for this purpose are those that exhibit a phenomenon known as LCST (lower critical solution temperature) phase behavior. It is understood that certain LCST polymers are hydrophilic below their LCST transition temperature and become reversibly hydrophobic above their LCST transition temperatures. In other words, below the LCST point the polymer shows high affinity towards water, consistent with its intrinsic molecular hydrophilicity. However, above the LCST point, the polymer repels water and shuns hydrogen bonding. This is evidenced by the observed thermogelation of polymer solutions above this transition temperature. As the polymeric or oligomeric LCST additive self-assembles on the surface of the NC elements (in the form of monolayer or a few molecular layers), drying of NC elements and the resulting morphology of the NC-containing material the dried state are affected so that the ultimate redispersion of such NCEs is facilitated.

For use in this setting, the LCST polymer can be added to the initial NC suspension at a temperature below the LCST polymer's transition temperature. The initial NC suspension is then heated to effect its drying. As water evaporates from the initial NC suspension during drying, its temperature rises and approaches the boiling point of water, coming to exceed the LCST polymer's transition temperature, at which point the LCST polymer loses its hydrophilic character and becomes hydrophobic. When it becomes hydrophobic, the LCST polymer's behavior changes: at that point it interferes with the hydrogen bonds that would be forming between the NC elements. The hydrophobic nature of the LCST polymer now drives the aggregation or disaggregation of the NC elements, instead of these processes being driven by the interaction of the hydrophilic cellulosic units of the NC elements.

In embodiments, selected LCST polymers can markedly or completely hinder the dense aggregation and consolidation of NC elements upon drying. In embodiments, the ability of selected LCST polymers to disrupt dense aggregation and consolidation of NC elements is independent of equipment selection and manner of drying. For example, the suspension containing the LCST polymer and the NC elements can be left quiescent during drying. A wide range of drying temperatures and pressures can be applied to the initial NC suspension in the presence of selected LCST polymers to accomplish aggregate-free drying. Dried NC materials that incorporate selected LCST polymers as described herein can be readily redispersed in water with gentle agitation or stirring, with minimal or no clotting or residual dense aggregations or consolidations identified in the redispersed suspension. These features allow for a wide latitude in parameters for redispersion and for processing the redispersed material.

In embodiments, the list below offers examples of LCST polymers and their analog short-chain oligomers that can be used as drying/dispersal additives to prevent dense aggregation and consolidation, and thereby to facilitate subsequent redispersion of NC elements.
Methyl cellulose (MC)
Carboxymethyl cellulose (CMC)
Sodium carboxymethyl cellulose (NaCMC).
Hydroxylethyl cellulose (HEC)
Hydroxypropyl cellulose (HPC).
Hydroxypropylmethyl cellulose (HPMC).
Ethylhydroxyethyl cellulose.
Polyvinylcaprolactam.
Poly(methyl vinyl ether)
Poly(N-isopropylacrylamide)
Poly(N,N-diethylacrylamide)
Block copolymer of poly (ethylene oxide) and poly (propylene oxide)
Poly(pentapeptide) of elastin

Note that thermogelation temperature of certain of the additives listed above depends on the type and degree of substitution and is tunable by structural design. Advantageously, a selected LCST polymer for use as a drying/dispersion additive can have a transition temperature that is greater than the ambient temperature (for example, >25° C.), so that the polymer remains in solution until the drying step commences.

ii. Volatile Small-Molecule Additive Systems

In embodiments, volatile systems comprising small molecule additives can be employed alone or in combination with other additives to act as drying/dispersal additives by creating space between the NC elements during drying and thereby preventing the NC elements from aggregating during the drying process. The selected small molecule additives for use with volatile systems are miscible with water and have a boiling point higher than that of the co-existing water. A small molecule additive useful in a volatile system is further characterized by its greatly lower hydrogen-bonding tendency compared to water. As the additive-loaded volatile system containing the NCEs and the selected small molecule additive undergoes drying, water molecules evaporate preferentially, leaving the small molecule additive behind due to its higher boiling point and thereby increasing the concentration of the additive in the remaining solution that remains in between adjacent NC elements. In embodiments, the molecular segments of the volatile small molecule additives comprise both polar and non-polar functionalities. Not being bound by theory, it is envisioned that the polar segments are attracted by the cellulosic hydroxy groups while the non-polar segments simultaneously interfere with hydroxy-hydroxy interactions, thus reducing adherence between and among the NC elements. Then, as the temperature in the system rises, the additive evaporates, leaving behind the NC elements surrounded by air and thus separated from each other. The resulting dried material, containing NC elements that are separated from each other by air, can be readily re-dispersed without forming indicia of aggregation or consolidation such as observable clumps/clots or concentration variations. The redispersed suspension comprises resuspended NC particles that are uniform in distribution within the suspension, wherein the NC elements retain their nano-size characteristics and can achieve redispersion with only very mild agitation/stirring.

In embodiments, the lists below offer examples of small molecule additives that can be used as drying/dispersal additives in the aforesaid volatile systems to prevent dense aggregation and consolidation, and thereby to facilitate subsequent redispersion of NC elements. Exemplary additives can be divided into two categories: non-ionic and cationic compounds.

Non-ionic candidates can include, without limitation:
Tri (propylene glycol) butyl ether (TPnB).
Di(propylene glycol) propyl ether (DPnP).
Propylene glycol butyl ether (PnB)
Propylene glycol propyl ether (PnP)
Ethylene glycol monobutyl ether.
Propylene glycol monomethyl ether acetate.
Propylene glycol diacetate.
Ethylene glycol diacetate.
Benzyl alcohol
1-Heptanol.
1-Hexanol.
Propane-1,2,3-triol (glycerol or glycerin)

Cationic candidates can include, without limitation:
Ethylene diamine
Diethylene triamine
Tetraethylene pentaamine.
1,3-Pentane diamine.
Piperazine.
1,2-Cyclohexane diamine
Aniline
Pyridine
Piperazine

In embodiments, the small molecule additives can evaporate completely from the initial NC suspension, just leaving behind the NC elements in suspension or in dried form without additive residue. However, in other embodiments, trace amounts of the small molecule additives can remain. For example, with certain cationic additives, their cationic groups can adhere to cellulose molecules, so that trace amounts of the additive remain adherent to the cellulose after complete drying. For most industrial applications, the trace residues of these additives do not pose a health or environmental problem. However, in embodiments, a biodegradable cationic small molecule such as 1,3-pentane diamine can be selected to avoid such issues.

iii. Blocking Agents

In embodiments, non-volatile small or large molecule additives can be employed themselves, apart from volatile systems as described above, to hinder hydrogen bonding and/or to create space between the NC elements during drying, thereby blocking interactions between the NC elements and thus preventing the NC elements from aggregating during the drying process. In embodiments, surface-functionalized nanoscale particles can be employed in the same manner. Such non-volatile small or large molecule additives and nanoscale particles employed to carry out this blocking function are referred to herein as blocking agents or blockers. As used herein, the term “blocking agent” or “blocker” includes any non-volatile chemical additive or nanoscale particulate material that itself hinders hydrogen bonding or creates spaces among NC elements, whether the substance is interposed between or among NC elements, or whether the substance offers temporary competitive binding sites for the NC elements, or otherwise.

As an example, caffeine and other xanthine derivatives are small-molecule blockers that can be used advantageously to facilitate isolation of NC elements from each other during a drying or concentrating process and their subsequent redispersion. Not to be bound by theory, it is envisioned that the aromatic nitrogen atoms in certain purines (such as caffeine and other xanthines or xanthine derivatives) and pyrimidines can become hydrogen-bonded with the hydroxy groups of the cellulose, presenting a flat, relatively non-polar, and molecularly-lubricating and water-screening outer surface to the NCEs, thus hindering adhesion between and among NC elements. Caffeine and other xanthines and xanthine derivatives can typically be used in quantities that do not present health or environmental problems even when used in sufficient dosages to facilitate NC dispersion.

As another example, certain humectant substances can be employed as blocker molecules. Humectants possess multiple hydrophilic sites such as hydroxyls, esters, and ammonium groups that can form hydrogen bonds with the surface of the NC elements, thus screening the interaction of these elements with each other via hydrogen bonding, and thereby impairing dense aggregation and consolidation. Moreover, these hygroscopic substances are biocompatible and are already widely used in the pharmaceutical, cosmetic, and food industries. Exemplary short and long humectant candidates include but are not limited to: glycerin, caprylyl glycol, ethylhexylglycerin, tribehenin, hydrolyzed soy protein, various amino acids, propylene glycol, methyl gluceth-20, phenyl trimethicone, hyaluronic acid, sorbitol, and gelatin. Polyols are another category of humectants usable as blocking agents, e.g., polyols such as (without limitation) arabitol, erythritol, galactitol, glycerol, isomalt, lactitol, maltitol, mannitol, ribitol, sorbitol, ribitol, and xylitol. Glycols are also effective blocking agent humectants, including without limitation propylene glycol, dipropylene glycol, tripropylene glycol, and polypropylene glycol.

As yet another example, fatty acids can be employed as blockers as well. Fatty acids contain hydrophilic sites and a hydrophobic tail. The hydrophilic site can form hydrogen bonds with the surface of NC elements, thus screening the interaction of these elements with each other via hydrogen bonding, thereby impairing aggregation. Preferably, fatty acids can be selected that do not contain so many hydrophilic sites that excessive hydrogen bonding will occur between NCE particles and the fatty acids. However, in embodiments wherein too many hydrogen sites may cause dense aggregation and consolidation, the hydrophobic tail of the fatty acid blockers can act to physically prevent dense aggregation and consolidation of NC elements by preventing or interfering with hydrogen bonding. In embodiments, the blocking agent can be a fatty acid, such as stearic acid, palmitic acid, myristic acid, lauric acid, capric acid, caprylic acid, caproic acid, and the like. To facilitate dispersion of the fatty acid in aqueous solutions of NC elements, a water-soluble fatty acid can be selected.

In embodiments, larger blocking molecules can be used for these purposes as well. For example, castor oil has a large blocky structure that has areas capable of hydrogen bonding allowing for the disruption of hydrogen bonds between fibers upon drying and by physical spacing fibrils apart with its long hydrocarbon chains. Maltodextrins are another category of bulky blocking molecules that have various degrees of polymerization and are capable of hydrogen bonding with NFC.

Surfactants may be used as blocking agents, alone or in combination, although they are typically more effective when used in combinations. Without being bound by theory, it is understood that their hydrophilic regions can interact with hydroxyl groups in NC elements such as NFCs and MFCs, with the hydrophobic tails of the surfactants helping to create space between NC fibers. Examples of surfactants suitable for these purposes include, without limitation, sodium lauryl sulfate, sodium laureth sulfate, sodium lauroyl sarcosinate, sodium caprylyl sulfonate, sodium octyl sulfate, ammonium lauryl sulfate, ammonium laureth sulfate, cocamide monoethanolamine, cocamide diethanolamine, polyoxyethylene sorbitan monopalmitate, polyoxyethylene sorbitan monostearate, polyoxyethylene sorbitan monooleate, capryl glucoside, Glucopon® alkylpolyglucoside (APG), and coco glucoside.

Furthermore, it is possible to use larger fibers such as pulp as blocking agents to prevent NFC agglomeration. Since these larger pulp fibers have not been fibrillated to the same degree as NFC, they have far fewer exposed hydrogen bonds and do not irreversibly agglomerate. Pulp fibers can further space out NFC fibrils to encourage bonding with the pulp rather than with themselves. It is possible, however, that some NFC fibrils may irreversibly agglomerate onto the pulp fibers during drying; for applications of NFC as a raw material, pulp as a blocking agent can inhibit full restoration of NFC properties such as viscosity after redispersion has been completed. Therefore, pulp is more suitable for use as a blocking agent in those situations when the final product is intended to be redispersed, such as a surface-interactive utensil in which the active agent is a cleaning agent. Under these circumstances, some degree of irreversible NFC agglomeration can be tolerated if there is enough pulp and/or dispersion aids included in the final product to allow the utensil to fall apart enough to release the active agent in contact with or in proximity to the surface being treated.

### 2. Redispersible and Redispersed Suspensions of NC Elements

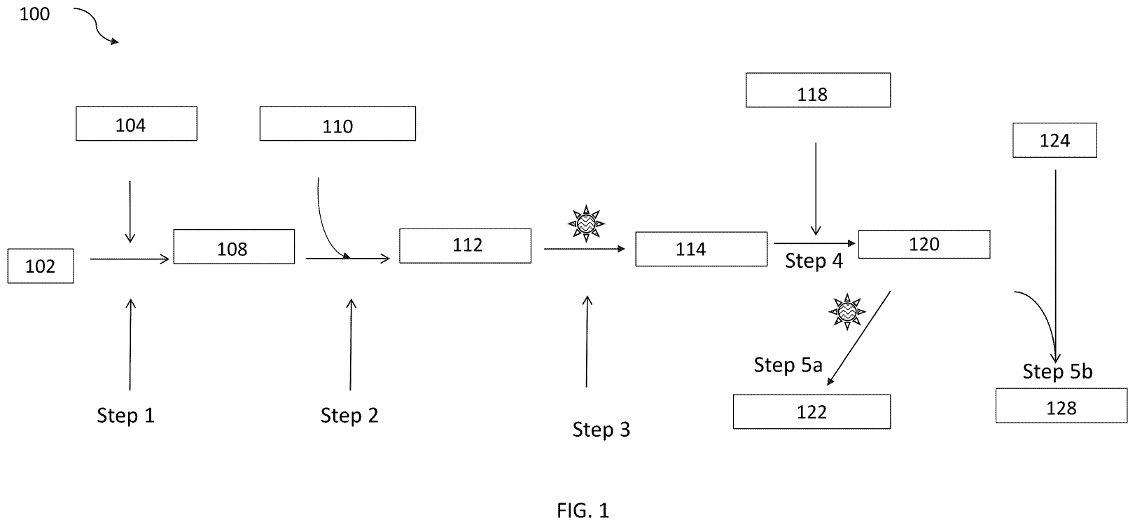

The block diagram of FIG. 1 depicts schematically the processes 100 involved in preparing redispersible suspensions of NC elements that can be further processed to yield redispersed suspensions of NC elements and materials made therefrom. As shown in FIG. 1, the processes 100 for producing a suspension of redispersed NC elements involve four steps.

Step 1 suspends a population of NCEs 102 in a suspension fluid 104 to produce the initial NCE suspension 108. Processes for forming initial NCE suspensions suitable for further processing using the formulations and methods disclosed herein are familiar in the art. To form such a NCE-containing suspension, cellulose sources can be processed using conventional mechanical techniques and optional chemical treatments to extract the component cellulosic nanomaterials (i.e., the NCEs) and retain them as suspended in a liquid medium. The NC elements thus extracted form the initial NC suspension, which can be treated to render them redispersible in the next step, using the disclosed formulations and methods.

In Step 2, a drying/dispersal additive 110 as described above is added to the initial NCE suspension 108, to produce a suspension of redispersible NCEs 112. As discussed previously, the drying/dispersal additive 110 allows the NCEs in the initial NCE suspension 108 to be redispersible. The redispersible suspension of NCEs 112 is dried partially or fully in Step 3, to produce a partially or fully dried material 114 (either, a “dried material”) containing redispersible NCEs. The dried material 114 containing the redispersible NCEs is then either ground/shredded and used as a dry ingredient (not shown), or suspended in a resuspending fluid 118 as shown in Step 4, thereby redispersing the NCEs and producing a suspension 120 of the desired concentration of redispersed NCEs.

In embodiments, the suspension 120 of redispersed NCEs can then be processed by itself, for example by drying the suspension 120 partially or fully or concentrating the suspension 120, either being represented by Step 5a. Such drying or concentrating as shown in Step 5a produces a simple NCE-based matrix 122 of dried, redispersed NCEs that can be formed or shaped as components of or substrates for articles of manufacture in any useful shape, such as sheets, fibers, solid articles, molded articles, etc. In exemplary embodiments, such a simple NCE-based matrix 122 can be formed as a continuous sheet.

As used herein, the term “matrix” refers to the continuous phase in a solid or semi-solid substance, for example, in a foamed substance. In a simple NCE-based matrix, the NCEs themselves are understood to be responsible for the organization and architecture of the matrix, with resulting performance attributes, although other additives can be added to the matrix to produce the advantageous features described above. As used herein, the term “simple NCE-based matrix” refers to such a structure in which the NCEs themselves produce the constitutive organization and architecture for the matrix. In a simple NCE-based matrix, the NCEs provide the framework within the matrix that imparts properties such strength, integrity, load-bearing capability, durability, or other mechanical or protective properties.

When the term “matrix” is employed herein, as in “simple NCE-based matrix,” it is understood that the process of matrix-formation described above need not produce a single, continuous simple NCE-based matrix, but can instead produce a plurality of simple NCE-based matrices that are more loosely connected to each other or are discontinuous. If a plurality of simple NCE-based matrices is produced by the processes as disclosed herein, the interrelationship of the matrices thus formed provides organization and architecture that can be carried over into the final simple NCE-based material. At a microscopic level, the structure is three-dimensional, highly porous, and typically forms a largely structurally amorphous network; however, semi-crystalline NCE matrices can be synthesized if nanocrystalline elements are used and/or crosslinking strategies, such as for example, the grafting and esterification of carboxylic acids onto the surface of NCEs, are employed. As used herein, the term “amorphous” refers to any solid formation in which the components are not organized in a definite and repeating lattice pattern. Amorphous structures usually enhance degradability. In addition, additive substances (not shown) can be easily incorporated in the amorphous simple NCE-based matrix 122 to produce advantageous features such as malleability, workability, heat tolerance, strength, or oleophobic or hydrophobic properties.

In more detail, the NCEs, when redispersed, form entanglements or attachments with each other that form one or more frameworks that act as matrices for the solid material. Physically mixing the liquid formulation comprising the redispersed NCEs can fragment a larger framework into smaller ones that associate more loosely with each other. This association of smaller fibrous frameworks within the larger matrix can provide the structural stability that is desirable for the simple NCE-based material. This arrangement is compatible with the addition of pulp or pulp-based substantives that can act as bulking agents, fillers, and the like. The architecture of the NCE frameworks within the simple NCE-based matrix allows a pulp or pulp-based material to be integrated into the overall matrix without substantially impairing its strength, stability, and/or durability.

Pulp-based or pulp-containing additives that do not contain NCEs can be added to a simple NCE-based matrix, in order to reduce the amount of NCEs that are required to produce desirable properties for those materials formed from the matrix As used herein, the term “pulp-based” refers to those materials that have been derived from pulp by processing, forming, or treating while retaining pulp or pulp derivatives within their substance. Pulp and pulp-based materials can be used with the formulations, compositions, and methods disclosed herein, to be formed or shaped as components of or substrates for articles of manufacture in any useful shape, such as sheets, fibers, solid articles, molded articles, etc. Such additives can act as low-cost bulking agents to add volume to the matrix so that a larger amount of simple NCE-based matrix is produced; in such a matrix, the redispersible or redispersed NCEs are added in combination with the bulking agent (for example, conventional pulp or other pulp-based substance) so that the final matrix has the desired mechanical properties.

Additive substances can become incorporated in or added to the simple NCE-based matrix 122 before, during, or after the processing of Step 5a: the additive substance(s) can be added to the suspension 120 of redispersed NCEs prior to the processing Step 5a, and/or they can be added as the suspension 120 is concentrated or partially or fully dried, and/or they can be added to the simple NCE-based matrix 122. A material comprising the simple NCE-based matrix 122, wherein the simple NCE matrix 122 provides the architectural framework for the material, and further comprising any additive substances can be termed a “simple NCE-based material.”

In a separate pathway, shown in Step 5b, the suspension 120 can be added to another, pre-existing matrix 124 to form a composite NCE-containing matrix 128. The pre-existing matrix 124 is a matrix as defined above (i.e., the continuous phase in a solid substance, for example, a foamed substance) that is formed with non-NCE materials, wherein the pre-existing matrix provides the constitutive organization and architecture to the overall solid substance. Many biopolymers can be employed to provide pre-existing matrices that can be combined with NCEs, for example starches, celluloses, chitosan, zein, and derivatives thereof such as cellulose acetate.

Redispersed or redispersible NCEs that are added to a pre-existing matrix can be termed “additive NCEs.” When additive NCEs are integrated into the pre-existing matrix, a composite NCE-containing matrix is formed: as used herein, the term “composite NCE-containing matrix” refers a structure in which the pre-existing matrix provides the constitutive organization and architecture for the overall composite solid and the additive NCEs are integrated into the pre-existing matrix to form the overall composite solid. As an example, FIG. 1 shows a population of redispersed NCEs in a suspension 120 that is added to a pre-existing matrix 124 to form a composite NCE-containing matrix 128. The population of redispersed NCEs in the aforesaid suspension 120 are a species of additive NCEs. In the embodiment depicted in FIG. 1, the pre-existing matrix 124 and any fibrous or structural elements contained therein provide the architectural framework for the composite NCE-containing matrix, and the additive NCEs are integrated into the pre-existing matrix 124, thereby forming the composite NCE-containing matrix 128.

A pre-existing matrix 124 can comprise an amorphous host matrix, or it can comprise a more discernibly ordered pattern of atoms or molecules in a regular lattice-like array, as might be seen in a crystalline structure. However, since the NCEs become integrated into the pre-existing matrix 124 to form the composite NCE-containing matrix 128, the more additive NCEs that the composite NCE-containing matrix 128 contains, the more the composite NCE-containing matrix 128 exhibits properties attributable to the NCEs. For example, a formulation comprising additive NCEs and a pulp-based bulking agent can provide significant strength to a composite NCE-containing matrix 128 in addition to any bulking or volume-filling produced by the pulp-based bulking agent alone. Such an arrangement can reduce cost by using the cheaper bulking agent while preserving strength by incorporating the NCEs. Other properties of the composite NCE-containing matrix 128 can be provided by the pre-existing matrix 124 alone or in interaction with any structural organization or other properties provided by the additive NCEs.

In embodiments, other additive substances can be included in the composite NCE-containing matrix to add or improve desirable features such as malleability, workability, heat tolerance, strength, or oleophobic or hydrophobic properties. Such additive substances can become available for or added to the composite NCE-containing matrix 128 before, during, or after the population of redispersed NCEs from the suspension 120 is added to the pre-existing matrix 124. In embodiments, the pre-existing matrix 124 already includes some or all of the desired additive substances, and their presence carries over into the composite NCE-containing matrix 128. In other embodiments, additive substances are included when the resuspended NCEs and the pre-existing matrix 124 are combined in Step 5b to form the composite NCE-containing matrix 128. In yet other embodiments, additive substances can be introduced into the composite NCE-containing matrix 128 after it is formed. The composite NCE-containing matrix 128 with its included additive substances yields a material, termed a composite NCE-containing material, that can be further processed, shaped, or otherwise formed into articles of manufacture, as described below in more detail.

### 3. Redispersed Nanocellulose Elements in Materials Useful for Producing Articles of Manufacture

As described above, materials, suspensions or formulations comprising redispersible (112) and redispersed (120) NC elements produced in accordance with the systems and methods disclosed herein can be included in matrices that are used to form NCE-containing materials, either as components of simple NCE-based materials formed solely or predominately from redispersible or redispersed NCEs, or as components of composite NCE-containing materials which comprise a composite NCE-containing matrix having redispersible or redispersed NCEs integrated into an pre-existing matrix. Both the simple NCE-based matrix 122 and the composite NCE-containing matrix 128 can be used to provide an architectural framework for materials comprising redispersed NCEs, wherein such materials can be formed or shaped to produce articles of manufacture.

The process of forming material(s) from the pliable state into the desired configuration or shape can be accomplished by many techniques familiar in the art, such as extrusion, calendaring, slot die forming, injection molding, thermoforming, blow molding, and the like. The process of fixing the material(s) in the desired configuration or shape can likewise be accomplished by many techniques familiar in the art, such as heating, applying prolonged pressure, and/or incorporating additives that permit hardening, fixation, or curing. The designated period for retaining the material(s) in the desired configuration or shape will be determined based on the intended use of such material(s) in the article of manufacture and the intended use of the article of manufacture itself (e.g., temporary vs relatively permanent use), and on the intended processes for the disposal of the material(s) and the article of manufacture disposal at the end of its lifespan.

As used herein, the term “surface-interactive utensil” applies without limitation to an article of manufacture intended to and dimensionally adapted to contact or come into close contact with a target surface to impart a treatment to the surface, to deliver an active agent to the surface, or both. A treatment is understood to be any intervention to a target surface that results in a desired effect on the target surface or to the substance or tissue or organism underlying the surface. The target surface can be any surface, whether that of a living organism or that of an inanimate object or a structure. Surfaces of living organism include external body surfaces such as skin and internal body surfaces such as the exterior or interior of organs or body cavities. For example, a surface-interactive utensil such as a sponge can be used to apply an active agent like a skin formulation to the skin, and can further be used to abrade (exfoliate) the skin before applying the skin formulation. As another example, a surface-interactive utensil such as a sponge or an applicator pad containing a pharmaceutical agent such as a coagulant to a bleeding blood vessel within the body, with the surface-interactive utensil being directed to the target surface within the body by a medical device such as a catheter or an endoscope. As yet another example, a surface-interactive utensil such as a sponge or an applicator pad containing plant nutrients, fertilizers, or even seeds can be directed to contact a plant or the soil surrounding the plant to enhance plant growth. Surfaces of inanimate objects or structures include any surface that may be found in the external aspects of or internal aspects of natural or manmade objects.

Because such a variety of target surfaces are treatable by surface-interactive utensils, a wide variety of shapes and forms for surface-interactive utensils can be envisioned that are consistent with the principles of the invention. A surface-interactive utensil can be formed in any shape that includes the active agent and is suitable for delivering the active agent to the target surface. Such utensils can be formed (without limitation), regularly or irregularly or in conformity with a shape related to the target surface. As non-limiting examples, surface-interactive utensils can be shaped to be flat, curved, pointed, rectangular, cuboidal, conical, cylindrical, spherical, toroidal, or otherwise, and to be sized three-dimensionally is adapted for directing the active agent to the target surface and permitting the manipulation necessary to reach the target surface and direct the active agent thereto. As an example, a surface-interactive utensil can be shaped to facilitate hand-held use (e.g., bricks, cubes, spheroid shapes and the like for household or personal care), or to reach into narrow apertures (e.g., pipes, crevices, interior surfaces of appliances or industrial equipment, or body cavities). In embodiments, surface-interactive utensils can be shaped to be applied specifically to a target surface, for example formed as a sheet to apply to the soil or around the body of a plant to deliver an active agent thereto; such a utensil can be designed to dissolve after encounter with water or sunshine after a sufficient time to release its active agent (fertilizer, nutrients, insecticides, and the like) to the target surface. Surface-interactive utensils can also be constructed to envelop or otherwise enclose a target surface, for example formed as a vessel or a container for a plant, with the utensil delivering an active agent to the soil and plant surfaces that it contains. Such a utensil, used for agricultural or horticultural purposes, can be constructed to have a limited lifespan, with the utensil lasting long enough to deliver the active agent to the target surface of a seedling plant (e.g., soil or plant surface), then decomposing when or after the treated seedling plant is ready for transplanting to a more permanent environment.

As exemplified by the foregoing, non-limiting examples, the term “active agent” refers to any substance or formulation delivered to a target surface by the surface-interactive utensil that accomplishes a desired effect of that utensil. As an example, in embodiments the surface-interactive utensil, such as a scrubber or an exfoliator, can have a desired effect on the skin surface simply by mechanical means, by dislodging a foreign material (such as dirt, grime, or old cosmetic products) that is distributed on the skin surface or by disrupting the surface itself to remove dead skin cells. In other embodiments, a surface-interactive utensil can affect the surface by distributing an active agent thereupon, such as a cleansing agent that facilitates removal of foreign material (such as dirt, grime, or old cosmetic products) or a skin cream that loosens that dead skin cells. In yet other embodiments, the surface-interactive utensil can be used to deliver an active agent to a surface (e.g., the skin's epidermis), wherein the active agent is intended to produce the desired effect not on the surface itself but rather by being absorbed through the surface to enter and affect the substance underneath (such as the dermis or the systemic circulation). It is understood that a single surface-interactive utensil can carry out several different functions simultaneously or sequentially. For example, the utensil can disperse the cleaning agent on the skin surface and also loosen dead skin cells. The utensil can be constructed so that a single aspect or material in the utensil performs the various functions, or there can discrete regions of the utensil that are responsible for the different functions. In embodiments, regions of the utensil can be transitional or ephemeral, designed to carry out their function and then dissolve, wash away, or otherwise disappear so that other areas can carry out different functions. For example, the utensil can be constructed in layers, with an outer, dissolvable absorbent layer intended to loosen the skin cells and then wash away, revealing an underlying layer that contains an active agent such as an emollient to treat the exfoliated area.

Categories of surface-interactive materials include, without limitation, absorbent materials, abrasive materials, and applicator materials. Absorbent materials are constructed to take up liquids or gels and retain them within their structure, allowing these substances to be removed from a target surface, or to be transported from one site to another, or to be applied to a target surface. Abrasive materials are constructed to treat a surface by grinding, rubbing, or otherwise damaging or wearing the surface. Abrasive articles can produce these effects via materials attached to or embedded in their surface, or materials such as biodegradable microbeads that are included within their substance. Applicator materials lack the storage capacities of absorbent materials, are intended to take up liquids or gels from a surface (as in a cleaning wipe) or to deliver liquids or gels to a surface (as in an applicator wipe such as a disinfectant applicator). Articles of manufacture formed from a material performing a single function can be described in terms of its function: an absorbent article, an abrasive article, or an applicator article. A single utensil can combine two or more types of materials to perform several different functions, serially (e.g., with dissolution of a component material after it has performed its function) or simultaneously. A single utensil comprising two or more types of materials can be constructed in layers so that the top layer performs its intended function (e.g., abrasion or exfoliation), then dissolves to reveal and activate an underlying layer that performs a second function (such as a cleaning function), followed by further dissolution that can reveal and activate another underlying layer that performs a third function (such as the application of a polish for a surface or a moisturizer for the skin). Arrangements of absorbent, abrasive, and applicator materials can be constructed to accomplish a variety of combined functions, as would be understood by skilled artisans in the relevant fields.

Surface-interactive utensils can include a wide range of active agents, such as cleaning agents for household or personal care purposes; personal care, pharmaceutical or medicinal agents (such as immediate-release or sustained-release treatments applied to skin or other bodily surfaces in human or other mammalian subjects, or topical treatment products such as sunscreens or insect repellants and the like) or other wellness-promoting agents (such as or nutraceuticals; cosmetic agents (e.g., pigments for inanimate surfaces, make-up and skin treatments, fragrances, skin nutrients, and the like); other materials or agents that treat the target surface); and agricultural or horticultural treatments for plants or soil surfaces. For the purposes of this disclosure, the term “amalgamate” and its grammatical derivatives and congeners is to be interpreted broadly in relation to surface-interactive utensils to cover any mechanism or arrangement by which the active agent is incorporated into, assimilated by, attaches to, or establishes a durable relationship with the utensil or any of its components or materials, including without limitations such situations as the active agent being at least partially encased or enclosed within the utensil, having the active agent embedded in the substance of the utensil or a component thereof, having the active agent coat a portion the utensil, enveloping the active agent within the utensil, or providing the utensil with layers so that the active agent is deployed on a layer that is interdigitated with other components of the utensil. For example, the utensil can comprise a foamed material that is shaped in a form that is amalgamated with the active agent, by a mechanism such as incorporating the active agent into its substance, coating a portion of the foamed material with the active agent, enveloping the active agent in the foamed material, or layering the foamed material to deploy the active agent on a layer that is interdigitated with other components of the utensil.

As used herein, the term “cleaning utensils” is used to apply to those surface-interactive utensils that carry out cleaning activities. As used herein, the term “cleaning” is to be broadly construed, referring to the process of removing unwanted substances, such as dirt, impurities, contamination, infectious agents, previously applied substances, and the like, from surfaces, for a wide variety of purposes, including aesthetic, hygienic, functional, safety-related, or environmental protection purposes, any of which can be the purpose for the cleaning. The term “cleaning utensils” can apply to utensils that are amalgamated with active agents that themselves carry out a cleaning activity, and can also apply to utensils that carry out a cleaning activity without amalgamating with such active agents.

While cleaning utensils for household purposes are used herein to illustrate the principles of the present invention and are a preferred embodiment, it is understood that the invention further encompasses those surface-interactive utensils used for personal care for which the combination of mechanical properties and decomposability is advantageous. For example, simple NCE-based materials as disclosed herein can be used to produce an absorbent material such as a sponge that can be used in an article of manufacture for single application or multiple applications of face makeup, soap, or a topically applied cosmetic or pharmaceutical substances, recognizing that such an absorbent article will have a limited lifespan and can thus remain sanitary during the period of time that it is in use. As another example, simple NCE-based materials as disclosed herein can be used to produce an abrasive material for use in an article of manufacture as a scrubber for skin cleansing or for exfoliating, with such utensil having a limited lifespan during which it remains sanitary throughout the period of time that it is in use. As yet another example, an applicator material such as a wipe can be used in an article of manufacture for cleaning skin surfaces or for delivering substances to the skin surface (e.g., disinfectants, fragrances, deodorants, sunscreens, insect repellants, cosmetics, shaving creams, and the like) where single use or minimal repeated use of the applicator article is envisioned.

a. Simple NCE-Based Materials

Materials comprising simple NCE-based matrices are referred to herein as “simple NCE-based materials” and can be used as substrates that can be formed into articles having a variety of shapes, with the mechanical properties of such formed articles being due at least in part to the structural framework provided by the matrix of dried, redispersed NCEs that is integral to the simple NCE-based material. Simple NCE-based materials can thus be used to form articles that have advantageous mechanical properties such as strength and stability but that are also engineered to be dissolvable or degradable at an appropriate time for consumer use. Such articles are envisioned to be relatively temporary in duration, and can be disposed of by biodegrading or composting.

This combination of mechanical properties and decomposability allows surface-interactive utensils to be constructed from simple NCE-based materials for deliberately ephemeral surface-interactive purposes, such as an absorbent article (e.g., a sponge), an abrasive article (e.g., a scrubber), or a applicator article (e.g., a wipe), where such a utensil is intended for a single use or intended for multiple uses that are limited in number or duration, and that is therefore intended to decompose rapidly after it has been used. This combination of properties can be tuned to allow surface-interactive utensils to be constructed for rapid, immediate, or delayed dissolving upon encountering water. For example, such a utensil can be designed for delivering a cleaning substance to a surface in a water-free environment, such as a polishing agent for a tabletop, with sufficient durability to permit the agent to be applied and rubbed into the surface; then, once adequate application has been accomplished and the surface is ready for buffing or polishing, the application utensil can be exposed to water in order to decompose it for disposal. In another embodiment, such a utensil can be tuned to have delayed solubility. As an example, water can be applied to such a foamed utensil, which then starts to solubilize, potentially releasing active agents, while being scrubbed against the target surface. During the few minutes in which the article is being used, an appropriate degree of structural integrity of the article is retained. However, full solubilization and decomposition still occurs upon high volume exposure to water (i.e., run under the kitchen sink and washed down the drain).

Simple NCE-based matrices, whose architecture is based on the three-dimensional arrangement of NCEs alone, are entirely bio-based, since they are formed from NC elements. Thus, they offer important alternatives to the petroleum-derived formulations that are used to produce conventional articles of manufacture used for similar purposes, and they provide a vehicle for engineering a foamed article having a temporally designed combination of mechanical properties and dissolvability that are consistent with the particular purpose of the article.

A significant limitation to the use of simple NCE-based materials is their vulnerability to oil, grease and water: simple NCE-based materials are substantially made from NCEs in combination with other, often cheaper, filler materials such as pulp and pulp-derived substances which tend to offer little intrinsic resistance to the entry of water or oil/grease into the material and their passage therethrough. This vulnerability is exacerbated by the cost of NCEs themselves: NCEs can be admixed with cheaper bulking agents or fillers to reduce the overall cost of a NCE-based material. Pulp or pulp-based substances are frequently employed for this purpose. However, such a material, termed “pulp-dominant” is especially susceptible to the effects of water and grease. In a pulp-dominant material without any other treatment, exposure to water or oil/grease can lead to a loss of structural strength or an actual loss of integrity of a formed article made from such materials.

As used herein, the term “pulp-dominant” refers to a material in which pulp or a pulp-based material is present in sufficient quantities that it can have substantial effect for the mechanical properties of the material. A pulp-dominant material can require additional NCE or other reinforcement to make it as strong, stable, or durable as a non-pulp-dominant simple NCE-based material, depending on the ultimate use of the material; furthermore, such a material can be treated with barrier formulations to make it resistant to the effects of water, oil, and grease, depending on the ultimate use of the NCE-based material. As an example, a pulp-dominant simple NCE-based material can be used to form sheets for one-time cleaning uses such as a cleansing wipe without much if any additional reinforcement, while a similar material intended for heavy-duty uses as a scouring pad, or multiple uses as a cleaning pad, can require more reinforcement since its ultimate use requires more strength and resilience.

A pulp-dominant material can also benefit from treatments to improve its oil and grease resistance and/or its water resistance, depending on the ultimate intended use for such a material. Simple NCE-based matrices can therefore be treated with formulations that impart oil and grease resistance (oleophobicity) and/or water resistance (hydrophobicity) to the matrix itself or to those materials comprising such matrices. Water resistance in a material is often measured by the water vapor transmission rate, which measures a material's water vapor permeability in units of gm/m²/day, or in g/100 in²/day; the term “water resistance” (WR) thus includes resistance to liquid water and resistance to water vapor. Oil and grease resistance (OGR) and water resistance (WR, and collectively with OGR, “OGWR”) properties can thus be integrated into the materials themselves or into the articles formed therefrom. These OGWR properties can also be termed “barrier properties,” and the substances or formulations that produce barrier properties can be termed “barrier-producing formulations.” Both oil/grease resistance (or oleophobicity) and water resistance (or hydrophobicity) can be individually termed a barrier property.

Barrier properties can be tuned within a simple NCE-containing material to permit differential permeability of the material to various fluids (whether oil, grease, or water). As an example, in embodiments a barrier-producing formulation may impart both OGR and WVR properties to the article it treats, with the relative strength of each property being tunable by adjusting the ingredients selected for the formulation itself, and/or by adjusting the relative amounts of its ingredients, for example to emphasize hydrophobicity or oleophobicity.

A wide range of ingredients can be used or combined to provide desired barrier properties. For example, a barrier-producing formulation that is suitable for use with simple NCE-based matrices can include a cellulose ether such as methylcellulose, and/or a resin acid. Alternative cellulosic and other bioderived and/or biodegradable ingredients for the barrier-producing formulation can include, without limitation, one or any combination of the following: CMC (carboxymethyl cellulose), NaCMC (sodium carboxymethyl cellulose salt), CA (cellulose acetate), CDA (Cellulose diacetate), cellulose triacetate (CTA), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate), lignin-containing NFCs or MFCs, NFCs or MFCs without modification, and/or surface modified NFCs or MFCs, PHAs (polyhydroxyalkanoates), PBS (Polybutylene succinate), PLA (polylactic acid), PVA (polyvinyl acetate), proteins (zein, pea protein, soy protein, keratin, and the like), lignin, chitosan, alginates, natural resins, abietic acid, gum rosin, polymerized rosin, hydrogenated rosin, natural waxes (carnauba, beeswax, candilla, bran, sugarcane wax, and the like), pectin, starch, cationic starch, and surface-modified starch. Methylcellulose is particularly advantageous in barrier-producing formulations for simple NCE-based matrices due to its oil and grease resistance, its high viscosity, and its unique lower critical solution temperature (LCST) that causes it to gel when heated. Cellulose acetates are also particularly advantageous ingredients in barrier formulations, because they can produce both oleophobic and hydrophobic properties.

Resin acids and combinations thereof (such as rosin, gum rosin, pitch, and the like) can be used alone or in conjunction with methylcellulose, cellulose acetate, or other naturally occurring or synthesized hydrophobic biopolymers (e.g., chitosan, cellulose derivatives such as cellulose acetates, and the like) to provide water resistance. In more detail, resin acids are bio-derived gums that are tacky and water-insoluble in their native state, characterized as unsaturated diterpene carboxylic acids with a phenanthrene ring structure, having the empirical formula C₁₉H₂₉COOH. Resin acids include abietic acid, palustric acid, levopimaric acid, neoabictic acid, dehydrogenated ibuptic acid, pimaric acid, isopimaric acid and sandaracopimaric acid. They can be separated into two categories according to their chemical structural formulas, abictic-type resin acids and pimaric type resin acids. The monomeric molecule of the abictic type resin acid has two conjugated double bonds and one isopropyl. Dehydrogenated abietic acid, abietic acid, palustric acid, and levopimaric acid are examples of abietic type resins. The monomeric molecule of pimaric-type resins has a methyl and vinyl at the C¹³ position and has two independent double bonds. This type of structure is predominantly found in pine-bearing resins and pine resin, such as pimaric acid, isopimaric acid, and sandaracopimaric acid, and pimaric resin acids.

Resin acids' carboxyl group(s) can react with a polyol (e.g., glycerol, erythritol, etc.) to form esters (thus binding three or four resin acid molecules together to create an “oligomer” of a basic resin acid building block such as abietic acid). Resin acids tend to be glassy and stiff at room temperature. Depending on plasticization, they can be softened by temperature increase, and amount of plasticizer used. Resin acids are compatible and miscible with a variety of oils/waxes to tune thermal or physical properties (such as but not limited to glass transition temperature, ductility, and hydrophobicity). For example, beeswax and carnauba wax are soluble in certain resin acids, thus affecting the melting and glass transition temperatures while also decreasing their solubility in solvents. Other examples of suitable oils and waxes to admix with resin acids include, without limitation:
Mineral oils and waxes (paraffins)
Beeswax
Carnauba wax
Flax seed wax
Candelilla
Lard
Coconut oil
Linseed oil
Eucalyptus essential oil
Cocoa butter
Sweet almond oil
Olive oil
Palm oil
Castor oil
Sunflower oil
Canola oil

The proportion of these ingredients in the barrier-producing formulation can be tuned to optimize its OGR properties and the WVR properties, and thus to engineer the desired amount of OGWR in the simple NCE-based material that are formed by adding the specific barrier-producing formulation to the simple NCE-containing matrix.

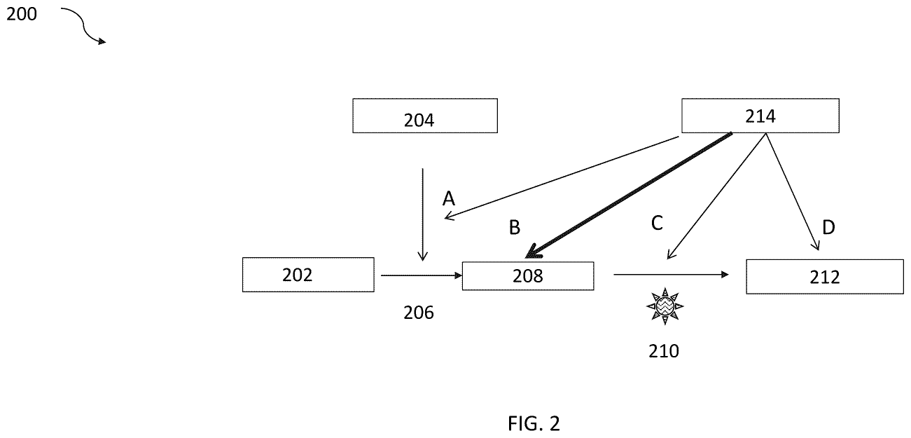

The block diagram of FIG. 2 illustrates schematically how the barrier-producing formulation can be added during the formation of the simple NCE-based matrix and its subsequent processing. The process 200 in FIG. 2 begins with providing a dried material 202 containing redispersible NCEs, where such dried material has been prepared substantially as described in connection with FIG. 1. The dried material 202 containing the redispersible NCEs is then ground/shredded and used as a dry ingredient, or suspended in a resuspending fluid 204 to resuspend the NCEs in the dried material and to form a suspension of the desired concentration of redispersed NCEs 208, substantially as described in connection with FIG. 1. The suspension of redispersed NCEs 208 is then subjected to partial or complete drying 210 to produce the simple NCE-based matrix 212 that can then be used to form the simple NCE-based material, substantially as described in connection with FIG. 1. The barrier-producing formulation 214 can be added at points A, B, C, and/or D. In more detail, the barrier-producing formulation 214 can be added as part of the step 206 wherein the dried material containing redispersible NCEs 202 is treated with the resuspending fluid 204 to produce the suspension of redispersed NCEs 208. For example, the barrier-producing formulation 214 can be added to the redispersing fluid 204, as suggested by its introduction at point A. The barrier-producing formulation 214 can also be added to the suspension of redispersed NCEs 208, as suggested by its introduction at point B. The barrier-producing formulation 214 can also be added during the step of drying 210, in which the suspension of redispersed NCEs 208 is processed, ultimately to form the simple NCE-based material 212, as suggested by its introduction at point C. Finally, the barrier-producing formulation can be added to the simple NCE-based material 212, as suggested by its introduction point at point D. Although a single barrier-producing formulation 214 is depicted in this Figure, it is understood that a plurality of barrier-producing formulations or barrier-producing formulation ingredients can be added at the different introduction points, or the same barrier-producing formulation can be introduced at different introduction points. A first barrier-producing formulation can be added at one introduction point, and a second barrier-producing formulation can be added at a second introduction point. Combinations of barrier-producing formulations and their ingredients can be introduced at any point during the process, using methods familiar in the art, such as (without limitation) mixing in the formulations, spraying them onto or into the designated substrate, or painting them on its surface.

An exemplary simple NCE-based material having OGWR properties can be produced as follows, with the barrier-producing formulation being added to a suspension of redispersed NCEs. A suspension of redispersed NCEs, prepared as discussed above, is provided, into which methylcellulose (MC) is added with or without a sugar alcohol plasticizer (glycerol, xylitol, maltitol, sorbitol, erythritol, mannitol, and the like). Adding these ingredients is intended to produce oleophobicity. The suspension of redispersed NCEs can contain NFCs, MFCs, or both. The suspension of redispersed NCEs can also include bulking agents such as pulp or pulp-based ingredients to produce more volume in the final simple NCE-based matrix and resulting materials.

Separately, a solution of rosin is prepared by mixing rosin into an alcohol or ketone solvent (e.g., ethanol or acetone) to achieve a 0.5-100 wt % (relative to the weight of the solvent) solution of rosin in the solvent. Rosin addition improves the hydrophobicity of the matrix and also improves its oleophobicity. Rosin efficacy for hydrophobicizing can be increased by heat-treating the rosin before dissolving it in the solvent, for example by heating the rosin at about 200° C. for about 10-30 minutes to remove impurities such as turpentine. Heat treatment will also increase the softening point rosin from 45° C. to 59° C., making it more resilient when subjected to heat during later stages of processing. In an embodiment, rosin can be loaded at an amount of 35 wt % relative to dry pulp weight, though it is understood that varying amounts of rosin can be added to achieve desired properties for the overall mixture, with exemplary amounts of rosin ranging from about 0.5 wt % to about 10 wt %, about 2 wt % to about 20 wt %, about 10 wt % to about 50 wt %, about 20 wt %-about 100 wt %, about 50 wt % to about 200 wt %, and the like, relative to dry pulp weight can be employed. Furthermore, in embodiments, it is understood that the ratio of redispersed (or redispersible) NCEs can be varied as well, to achieve desired properties for the overall mixture. In an exemplary embodiment, the ratio of the redispersed (or redispersible) NCEs to MC is about 1:3. Other ratios of NCEs to MC ranging from 5:1 to 1:3 can be employed.

After this solution has been prepared, with the rosin adequately dissolved, it can be mixed into the MC-containing suspension of redispersed (or redispersible) NCEs. A small amount of the solvent used to prepare the mixture can be added to the suspension of NCEs, before the rosin mixture is added, to encourage homogenization. The mixing process can take place vigorously, for example pouring rosin-based formulation slowly into the NCE containing resuspension at medium to high shear, or sprayed as a fine mist into solution at relatively low shear, to nucleate a fine suspension of rosin in the liquid phase of the NCE/MC-containing suspension. In certain embodiments, it is advantageous to add the rosin solution as a highly pressurized stream. Another method of rosin addition involves adding emulsified rosin. In one practice of this method, rosin is solubilized in ethanol and combined with an aqueous solution of an emulsification agent (such as PEG or polysorbate) and a stabilization agent (such as methylcellulose or xanthan gum). This mixture can be added to water at high shear, preferably under homogenization conditions, to create a suspension of rosin microparticles that are relatively stable in water. Following combination of the aforementioned ingredients the resulting mixture can be partially or fully dried, producing the simple NCE-based matrix that can be processed to yield the simple NCE-based materials. After the simple NCE-based matrix having OGWR properties is produced by combining the ingredients above, this matrix can then be formed into a simple NCE-based material that can be used to produce articles of manufacture.

In exemplary embodiments, OGR and WVR materials as disclosed herein can be used as barrier-producing formulations with simple NCE-based materials as mix-in additives. In more detail, OGR and/or WVR formulations can be mixed into the simple NCE-based material, which then can be shaped (e.g., thermoformed) into an article of manufacture.

As an example, household cleaning utensils or personal care utensils such as absorbent articles (e.g., sponges), abrasive articles (e.g., scrubbers), or applicator articles (e.g., wipes or cleaning pads), or combinations thereof, formed from simple NCE-based materials can be prepared having OGR properties and/or WVR properties, enabling these utensils to deliver liquids or gels containing active agents to targeted surfaces, and enabling the utensils to retain their integrity during use. For example, household cleaning utensils can include sponges or other absorbent articles or materials for removing spills or soil and for conveying or transporting cleaning products, and can also include scrubbers or abrasive materials for removing soil, stains, or superficial surface layers, and can further include wipes and sheets and other applicator articles or materials for delivering a gel or liquid containing active agents onto a surface and/or removing it therefrom. As another example, personal care utensils can include sponges or other absorbent articles or materials for retaining liquids or gels containing active agents within their soft, porous substance so that those fluids can be applied as cosmetics, skin cleansers, pharmaceuticals, and the like; in addition personal care utensils can include abrasive articles or materials that can be used for cleansing or exfoliating; and personal care utensils can include applicators for cleansing skin and other body surfaces (e.g., wipes) or for delivering a liquid or gel containing active agents to such surfaces.

In embodiments, simple NCE-based materials can be pulp-dominant, with appropriate adjustments of amounts of NCEs and barrier-producing formulations, based on amount of pulp or pulp-based materials they contain. In embodiments, the barrier-producing formulation can be integrated into the simple NCE-based formulation (as described above) at any concentration; then, before molding/thermoforming takes place, the mixture can be heated to just above the lower critical solution temperature of the LCST polymer component of the barrier-producing formulation. This procedure allows the LCST polymer dispersed within the mixture to precipitate (or “crash out”) onto the surface of the simple NCE-containing matrix structure.

In embodiments, filler particles can be added to simple NCE-based matrices and materials for bulking effect, and/or to act as pore closers. As well, filler particles can affect mechanical properties such as strength, toughness, flexibility, and elasticity. Filler particles can be used in addition to barrier-producing formulations, or instead of them. For example, in pulp-dominant embodiments, filler particles can interact with the pulp fibers and the simple NCE matrices to impart barrier properties such as oleophobicity and/or hydrophobicity.

Filler particles can include, without limitation, large or small particles of any shape, or mixtures of different sizes and shapes, made from natural or artificial materials, including organic or inorganic components. By way of illustration, particles useful for this purpose can comprise, without limitation, sand materials, ceramic materials, resinous materials, glass materials, polymeric materials, rubber materials, chemically-active materials such as fatty acids, surfactants, and sugar alcohols, organic materials such as nutshells that have been chipped, ground, pulverized or crushed to a suitable size (e.g., walnut, pecan, coconut, almond, ivory nut, Brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, specific particles such as solid glass, glass microspheres, fly ash, silica, alumina, fumed carbon, carbon black, graphite, mica, boron, zirconia, talc, kaolin, titanium dioxide, calcium carbonate (e.g., precipitated calcium carbonate (PCC) or ground calcium carbonate (GCC)), calcium silicate, flame retardants (such as, but not limited to halogenated (chlorinated or brominated), phosphorous-based, nitrogen-based, inorganic/mineral based flame retardants, for example, hexabromocyclododecane (HBCD), triphenyl phosphate (TPP), tricresyl phosphate (TCP), phenol isopropylated, phosphate 3:1 (PIP 3:1)) and the like, as well as combinations or composites of these or similar different materials.

Advantageously, in certain embodiments filler particles can be selected that can be hydrophobic in nature, or that can be made hydrophobic (e.g., functionalized PCC), for example by linking or coating them with a hydrophobic material such as stearic or oleic acid. In embodiments, the filler particles can comprise waxes, either as the substance for the particle itself or as a coating for other particles, and these waxes can be in wax form or emulsion form (oil in water wax emulsion). For example, a waxy substance such as beeswax, soybean wax, carnauba wax, and the like, can be used, either as a base particle or as a coating for other filler particles. As used herein, the term “wax” refers to any hydrocarbon that is lipophilic and a malleable solid near ambient temperatures, typically having a melting point above about 40° C. As examples, waxes can include long-chain aliphatic hydrocarbons typically having 20-40 carbon atoms per molecule, or fatty acid/alcohol esters typically containing from 12-32 carbon atoms per molecule, such as myricyl cerotate, found in beeswax and carnauba wax. Filler particles can be mixed into the barrier-producing formulation to impart pore-clogging functionalities.

b. Composite NCE-Containing Materials

As described above, materials comprising composite NCE-containing matrices are referred to herein as “composite NCE-containing materials,” and can be used as substrates for forming articles having a variety of shapes, with the mechanical properties of such formed articles being due at least in part to the presence of the NCEs in conjunction with the pre-existing matrix. Redispersed (or redispersible) NCEs can be integrated into the overall composite NCE-containing matrix in a number of ways.

For example, redispersed (or redispersible) NCEs produced as described herein can act as fillers in composite NCE-containing matrices. Fillers are understood to improve mechanical and barrier properties of organic substances such as biobased or petroleum-derived plastics, and inorganic materials, and/or to make them or products made from them more economical to produce or ship, for example by requiring less amounts of expensive ingredients, or by making them more lightweight. Redispersed (or redispersible) NCEs produced as described herein can also be combined with other bulking agents such as pulp or pulp-based substances to increase the final volume of the composite NCE-containing matrix while retaining strength through the presence of the additive NCEs. While NCEs have already been used as fillers in plastics, their use has been limited by their resistance to redispersibility.

Other non-NCE filler particles can also be added to composite NCE-containing matrices similarly to how such filler particles can be added to simple NCE-based matrices. The role of filler particles has been described above in detail with reference to simple NCE-based materials; mutatis mutandis, that description can be applied to the use of filler particles for composite NCE-containing materials. As examples, filler particles can be added to composite NCE-containing matrices for bulking effect, and/or to act as pore closers. As well, filler particles can affect mechanical properties such as strength, toughness, flexibility, and elasticity. Filler particles can be used in addition to barrier-producing formulations, or instead of them; in either case, the filler particles can interact with the pre-existing matrices and/or the composite NCE-containing matrices to improve mechanical properties or to impart barrier properties such as oleophobicity and/or hydrophobicity. Filler particles can also be designed to undergo one or multiple phase transitions during processing to further improve the barrier properties, as the discrete filler particles fuse into a continuous or semi-continuous web or layer throughout, or on the surface of, the matrix.

As another example, redispersed NCEs produced as described herein can provide reinforcement of composite materials, permitting a dramatic expansion of new uses for such composite materials. As used herein, the term “reinforcement” refers to an improvement of a mechanical characteristic that is found in the pre-existing matrix pertaining to strength, hardness, toughness, brittleness, stiffness, cohesion, flexibility, durability, or impact resistance, or a provision of such a mechanical characteristic if it is not already present in the pre-existing matrix. A composite NCE-containing matrix having improved mechanical properties as compared to the pre-existing matrix can be termed “reinforced,” with the reinforcement evident in the composite NCE-containing matrix being attributable to the presence of the NCEs.

Composite NCE-containing materials, formed from composite matrices in which the redispersed (or redispersible) NCEs are integrated into pre-existing matrices, can be used as substrates for forming a multitude of products. After they are mixed into the pre-existing matrix, the additive NCEs can be deployed as particles or as more elongated fibrous structures, and can align with themselves in a straight or randomly oriented way, to form networks or other internal architecture in combination with the pre-existing composite matrix that is embedded within the composite NCE-containing material. In embodiments, the three-dimensional matrix framework of the pre-existing matrix substance is coated with and/or impregnated with additive NCEs to form the composite NCE-containing matrix, wherein the presence of the additive NCEs imparts a specialized property that exceeds those found in the pre-existing matrix, or that is not found in the pre-existing matrix. For example, the composite NCE-containing material can exhibit a specialized mechanical property such as strength, hardness, toughness, brittleness, stiffness, cohesion, durability, impact resistance, optical transparency, and the like, where the presence of the NCEs in the composite NCE-containing material produces or improves upon that specialized mechanical property. As another example, the composite NCE-containing material can exhibit a specialized barrier property such as an OGWR property that can be present in the pre-existing matrix but is improved in the composite NCE-containing material, or that is absent in the pre-existing matrix but is provided in the composite NCE-containing material.

In embodiments, combining resuspended NCEs with a pre-existing matrix can allow the presence of the NCEs to act as pore closers in their interaction with the pre-existing matrix. Under these circumstances, the resuspended NCEs can interact with the pre-existing matrix so that it coats it or fills in the pores or gaps within the network provided by the pre-existing matrix. In this capacity, the NCEs and any matrices that they form can act as pore-closers to fill the gaps in the pre-existing matrix, thereby acting as plugs to permit the passage of other molecules, such as oil and grease, through the composite NCE-containing matrix. This mechanism is similar to the behavior or NCEs as pore-closers for simple NCE-based materials.

More generally, the process of formulating composite NCE-containing materials from composite NCE-containing matrices can be engineered in order to produce the desired material properties. The production of OGWR properties by the incorporation of barrier-producing formulations in such materials is one example of how composite NCE-containing matrices can be engineered to produce such material properties. Pre-existing matrices can be formulated to make them especially suitable for combining with the redispersed (or redispersible) NCEs in order to form the composite NCE-containing matrices and to produce composite NCE-containing materials. For example, the degree of flexibility in a product formed from the composite NCE-containing materials can be fine-tuned by varying the composition of the pre-existing matrix, the amount of additive NCEs used in the pre-existing matrix to form the composite NCE-containing matrix, and/or the amount of various additives intended to optimize properties of the final composite NCE-containing material. By selection of appropriate polymers and additives for the pre-existing matrix within which NCEs are integrated to form a composite material, properties such as structural strength, resilience, elasticity, water resistance, oil and grease resistance, and the like, can be imparted to manufactured articles formed therefrom, in combination with biodegradability.

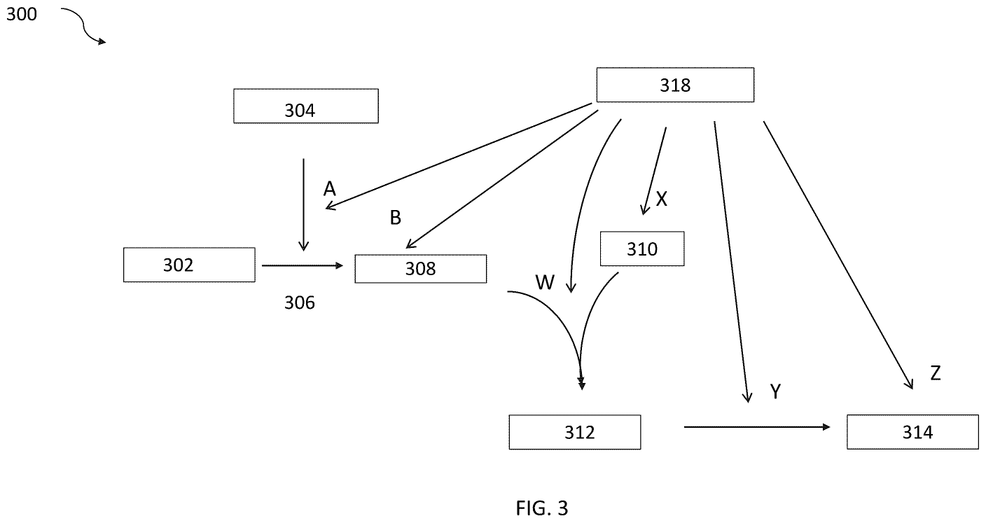

The block diagram of FIG. 3 illustrates schematically how the barrier-producing formulation can be added during the formation of the composite NCE-containing matrix and its subsequent processing. The process 300 in FIG. 3 begins with providing a dried material 302 containing redispersible NCEs, where such dried material has been prepared substantially as described in connection with FIG. 1. The dried material 302 is then treated with a resuspending fluid 304 in a resuspending step 306 to form a suspension of redispersed NCEs 308, substantially as described in connection with FIG. 1. The suspension of redispersed NCEs 308 is then combined with a pre-existing matrix 310 to produce the composite NCE-containing matrix 312, substantially as shown in Step 5a in FIG. 1. The composite NCE-containing matrix 314 can be combined with additives and/or further processed to form a composite NCE-containing material. The barrier-producing formulation 318 can be added at points A and B substantially as described in connection with FIG. 1. Alternatively, or in addition, the barrier-producing formulation 318 can be added at one or more of points W, X, Y, and Z. In more detail, the barrier-producing formulation 318 can be added as the suspension of redispersed NCEs 308 is mixed with the pre-existing matrix 310, as indicated by point W; the barrier-producing formulation 318 can be added to the pre-existing matrix 310 before it is mixed with the redispersed NCEs 308, as indicated by point X; the barrier-producing formulation 310 can be added to the composite NCE-containing matrix 312 as it is processed to become the composite NCE-containing material 314, as indicated by point Y; and/or the barrier-producing formulation 310 can be added to the composite NCE-containing material 314, as indicated by point Z. For this last type of application, advantageously the barrier-producing formulation can be sprayable to permit easy application, whether to the surface of the composite NCE-containing material 314 or to the surface of formed articles manufactured therefrom (not shown). Although a single barrier-producing formulation 318 is depicted in this Figure, it is understood that a plurality of barrier-producing formulations or barrier-producing formulation ingredients can be added at the different introduction points W, X, Y, or Z. A first barrier-producing formulation can be added at one introduction point, and a second barrier-producing formulation can be added at a second introduction point. Combinations of formulations and/or barrier-producing formulations ingredients can be introduced at any point during the process.

In embodiments, bio-based polymers can be used to form the pre-existing matrices that are combined with additive NCEs to form composite NCE-containing matrices with advantageous properties. Under these circumstances, all the structural components of the composite NCE-containing matrix are bio-based, as is the composite NCE-containing material formed from the composite NCE-containing matrix. This composite NCE-containing material can be used as a formable substrate to be shaped or otherwise formed into articles of manufacture. Producing this formable substrate from bio-based components (i.e., redispersed (or redispersible) (either, additive) NCEs and a bio-based pre-existing matrix) offers sustainability benefits, both in eliminating reliance on petrochemical raw materials and in facilitating the degradation and disposal of products formed from such materials.

In those embodiments that use bio-based polymers to form the pre-existing matrix, the constitutive bio-based polymer forming the pre-existing matrix can be a homopolymer, copolymer, polymer blend, or any combination of the foregoing. Additive ingredients can be combined with the constitutive bio-based polymer to optimize properties of the pre-existing matrix. For example, cellulose acetate (CA) and cellulose acetate butyrate (CAB) can be blended together in an acetone solution to form a pre-existing matrix; alternatively, one of the two cellulose polymers could be used independently. Additional or alternative cellulosic polymers that can be used for the pre-existing matrix include cellulose acetate propionate, methyl cellulose, hydroxypropyl methyl cellulose, cellulose acetate phthalate, hydroxyethyl cellulose, chitosan, and the like. In embodiments, one or more plasticizers can be added to the pre-existing matrix to soften and increase its flexibility. Bio-based plasticizers that can be added into the pre-existing matrix can include fatty acids, polyols, cpoxidized triglyceride vegetable oils, alkyl esters of adipic and citric acids, and the like; examples of such plasticizers include, without limitation, triglycerin, tributyl citrate, triethyl citrate, cpoxidized soybean oil and the like. Bio-based resinous materials, such as gum rosin, can be added to stiffen the pre-existing matrix and limit the degree of flexibility. Such materials can have the additional advantage of aiding in hydrophobization of the matrix and any subsequent materials derived therefrom if water resistance is desired for end use. Further additives can be included to optimize material properties for end use applications. For example, fillers and bulking agents can be added: pulp can be included as a filler or bulking agent in the pre-existing matrix to reduce cost and improve texture; precipitated calcium carbonate and stearic acid can be added in the pre-existing matrix to improve hardness and hydrophobicity. Alternatively, or in combination with other additives, an oil-grease resistant and/or water-resistant (OGWR) formulation can be incorporated into the pre-existing matrix to obtain hydrophobicity and oleophobicity as desired. Biodegradability-boosting additives can be used to aid in quick decomposition of the matrices after disposal; for example, silica particles can be integrated into a CAB-plasticized matrix. It is also possible to magnetize the pre-existing matrix or the composite NC-containing matrix with additives such as gamma ferric oxide. While the additives are described above as being added to the pre-existing matrix, it is understood that they can be introduced directly into the composite matrix formulation (i.e., after the additive NCEs are combined with the pre-existing matrix) in addition to or instead of introducing them into the pre-existing matrix.

In embodiments, barrier-producing formulations can be prepared that contain biopolymers as additives to impart OGWR properties or other useful properties to composite NCE-containing materials, similar to how such additives can be used with barrier-producing formulations that are combined with simple NCE-based materials. Such additives can be added to the barrier-producing formulation, which then can be combined with the composite NCE-containing matrix as described above. Such biopolymers can include, without limitation, exopolysaccharides such as bacterial cellulose, kefiran, pullulan, levan, gellan, and other polysaccharides such as alginate, celluloses, carrageenan, gum Arabic, starch and plant glucomannans-like locust bean gum, mannan, guar gum, and the like. Biopolymers can also include biopolyesters such as polyhydroxyalkanoates and polylactic acid derivatives. Advantageously, certain exopolysaccharides such as pullulan, kefiran, cellulose, levan, gellan, and the like can be used to form films, which can be advantageous for those barrier-producing formulations that are used as coatings for composite NCE-containing materials and useful articles made therefrom.

In an embodiment, a composite NCE-containing matrix for use in a composite NCE-containing material can be prepared as follows. In this embodiment, the bio-based pre-existing matrix is prepared to include performance-enhancing additives, and this pre-existing matrix is then combined with the redispersed (or redispersible) (either, additive) NCEs. To prepare the bio-based pre-existing matrix, the matrix-forming ingredients are dissolved in a solution of acetone to form a 12 wt % solution of those ingredients. Matrix-forming ingredients can include polymeric ingredients (e.g., cellulose acetate (CA), cellulose acetate butyrate (CAB), and the like; and other cellulose ethers such as methyl cellulose, carboxymethyl cellulose, hydroxymethyl cellulose, and the like; and other bio-derived polymers such as polyethylene glycol (PEG), and the like, or combinations of such polymer ingredients), which can be combined with plasticizers (e.g., glycerol, triglycerin, triacetin, triethyl citrate, acetyl triethyl citrate, oleic acid, and the like), along with rosin or derivatives thereof, fillers such as calcium carbonate or silica, bulking agents such as pulp or pulp-based materials, and/or fatty acids (preferably saturated) such stearic acid, lauric acid, palmitic acid, oleic acid, and the like. As an example, the CAB or other biopolymer can be added in a range from about 60% to about 90%; the plasticizer can be added in a range from about 0.1% to about 20%; the gum rosin can be added in a range from about 1-10% and/or about 10% to about 40%. As another example, the CAB or other biopolymer can be added in a range from about 30%-60% or about 60% to about 90%; the plasticizer can be added in a range from about 0.1% to about 20%; stearic acid can be added in a range from about 5% to about 25%, and calcium carbonate can be added in a range from about 0.5% to 3% and/or about 3% to about 17%, with the ratio of stearic acid to calcium carbonate at about 3:2.

For example, ingredients including rosin, a plasticizer, and cellulose acetate butyrate (or any other biopolymer or combination of biopolymers) are combined along with other additives; under certain circumstances the order of combination can matter. In embodiments, the least viscous ingredients are combined first (rosin, PCC, stearic acid), with subsequent addition of the CAB, followed by addition of the plasticizer. The solution is stirred until the mixture is homogeneous and no clumps remain. This solution then thickens to provide the pre-existing composite matrix into which the additive NCEs are to be incorporated.

In parallel, the additive NCEs are prepared. To do so, a selected amount of dried, redispersible NC-containing material prepared as described above is redispersed in a redispersing fluid such as water, mixing thoroughly with an overhead mixer. In this way a formulation of redispersed additive NCEs is produced. The formulation of redispersed NCEs can contain an amount of redispersed NCEs suitable to achieve the desired properties in the composite NCE-containing material. An amount of redispersed NCEs ranging from about 0.5% to about 50% (wt %) of the entire composite NCE-containing matrix can be used, with a range from about 5% to about 40% being advantageous. Using less water for this formulation will facilitate the drying of the material into which the additive NCEs are to be incorporated, assisting with its moldability. This formulation of additive redispersed NCEs is then combined with the pre-existing matrix to produce the composite NCE-containing matrix. While the foregoing embodiment and the process for making it has been described using a formulation of additive redispersed NCEs, it is recognized that redispersible NCEs can also be used as additive NCEs to be combined with the pre-existing matrix to produce the composite NCE-containing matrix. However, the use of a fluid comprising redispersed NCEs allows for increased convenience, more precise mixing, and more uniform distribution of ingredients and NCEs within the pre-existing matrix under most circumstances.

In the embodiment described above, no further ingredients are added to the composite NCE-containing matrix, since the appropriate ingredients have been added to the pre-existing matrix already; the combination of ingredients described above thus yields a composite NCE-containing material. However, if further ingredients are to be added to the composite NCE-matrix to yield the composite NCE-containing material, the composite NCE-containing matrix and any other desired ingredients can be mixed together, for example by stirring them by an overhead stirrer, to yield the composite NCE-containing material. This initial forming process to produce the composite NCE-containing material can be further adjusted based on the viscosity requirements for the manufacturing process being used to produce the desired formed article from the composite NCE-containing material.

### 4. Foamed Articles of Manufacture

a. Foaming Methods for NCE-Based and NCE-Containing Matrices and Materials

Both simple NCE-based materials and composite NCE-containing materials can be incorporated in foams that can be used for a wide variety of articles of manufacture, as will be described below in more detail. Foams can be made either from simple NCE-based matrices or from composite NCE-containing matrices, with such matrices being formed from suspensions of redispersed (or redispersible) NCEs as described above. Either a simple NCE-based matrix or a composite NCE-containing matrix can act as a substrate for foaming, as can a simple NCE-based material or a composite NCE-containing material. Substrates for foaming can further be equipped with or combined with other additives that provide advantageous properties such as barrier properties.

As used herein, the term “foam” refers to a multiphase system of dispersed media, comprising gas bubbles distributed in a liquid, semisolid or a solid medium wherein the density of the multiphase system is less than the density of the liquid, semisolid or solid medium alone. The term “foaming” refers to the process of making a foam; an article, material, matrix, etc. that is “foamed” comprises a foam and is formed at least in part by foaming.

For the purposes of this disclosure, a reference to a foam includes open-cell foams and closed-cell foams. Closed-cell foams are recognized as having particular utility for applications requiring more durability, such as scouring pads or cleaning pads for heavy-duty uses or for abrasive purposes. Open-cell foams are useful in utensils used for less demanding applications, such as lighter cleaning tasks, such as sponges used for cleaning, or scouring pads, or other materials or formed articles that serve as vehicles for cleaning agents and/or as applicators therefor.

To produce a foamed material as described herein or to produce a foam in a simple NCE-based material or a composite NCE-containing material, the material or its precursor matrix can be exposed to the action of a foam-forming substance, or can be exposed to the action of a foam-forming process (e.g., mechanical mixing), or both. Those substrates that are combined with foam-forming substances or are subjected to foam-forming processes or both, in order to produce a foam are termed “foam-forming formulations.” As used herein, the term “foam-forming substance” refers to a chemical substance that carries out the foaming process for a foam-foaming formulation, facilitates the foaming process, or improves the quality of the foam that is formed from the foam-forming formulation. As used herein, the term “foam-forming process” refers to activities such as heating or mechanical whipping that carry out the foaming process for a foam-forming formulation, facilitate the foaming process, or improves the quality of the foam that is formed from the foam-forming formulation.

In an illustrative embodiment, a foaming formulation or a foamed material can be prepared from a NCE-based or NCE-containing matrix as follows. First, a population of NCEs can be treated to permit redispersibility and can be redispersed, as described above. Next, an unsaturated, saturated, or supersaturated solution of a cellulosic polymer (such as, but not limited to, MC (methyl cellulose), CMC (carboxymethyl cellulose), NaCMC (sodium carboxymethyl cellulose salt), CA (cellulose acetate), CDA (cellulose diacetate), cellulose triacetate (CTAs), CAB (cellulose acetate butyrate), CAPh (cellulose acetate phthalate), CAP (cellulose acetate propionate), EC (ethyl cellulose), HEC (hydroxyethyl cellulose), EHEC (ethyl hydroxyethyl cellulose), HPC (hydroxypropyl cellulose), HPMC (hydroxypropyl methylcellulose), HPMCP (hydroxypropyl methylcellulose phthalate), HPMCAS (hydroxypropyl methylcellulose acetate)) is prepared in its proper solvent, with the optional addition of a plasticizer. Depending on the cellulosic polymer selected, an appropriate plasticizer can be a polyol (e.g., glycerol, xylitol, diglycerol), a fatty acid, triacetin, triethyl citrate, acetyl triethyl citrate, tributyl citrate, diethyl phthalate, dibutyl phthalate, dioctyl phthalate, or any blocking agent to reduce physical or chemical interaction, such as hydrogen bonding). The redispersible NCEs can be added to this solution dry or can be prepared as a slurry of 1-10% redispersed NCEs before adding. When the cellulosic polymer solution and the suspension of redispersible NCEs are not miscible, a small amount of surfactant (e.g., capryl glucoside) can be added to encourage homogenization of the mixture. Pentane, often mixed with ethanol, is added to the solution as the blowing agent.

The mixture can optionally be combined with a barrier-producing formulation, such as a hydrophobic barrier-producing formulation comprising agents such as CA, oils, resinous, materials, waxy materials; (e.g., resin, rosin, beeswax) and the like, or an oleophobic barrier-producing formulation comprising agents such as MC, pulp, silicone dioxide, calcium carbonate coated with stearic acid, and the like, in order to impart the desired barrier properties. A barrier-producing formulation, for example comprising a hydrophobic starch, a hydrophobic cellulosic polymer, a fatty acid, surfactant, or a water in oil or wax emulsion, can be added in ratios ranging from 1:3 barrier additive to NCE to 15:1 barrier additive to NCE dry weight, and preferably from 3:1 to 9:1, in order to produce desired barrier properties. In certain embodiments, the barrier-producing formulation can act as a substitute for the cellulosic polymer or can work in tandem with it, while in yet other embodiments, the cellulosic polymer itself can provide the desired hydrophobicity or oleophobicity.

Mixtures as described above, ready for further treatment to produce foaming, are examples of “foam-forming formulations.” Foaming can be produced easily in such mixtures because of their high viscosity. Thus, the addition of viscosifiers provides phase interface stabilization, can cause crosslinking, and increase the elasticity of the sample. Some thickening agents, without limitation, include gums such as xanthan, guar, agar, locust bean, tamarind, acacia, gellan, welan, carrageenan, and the like. Given the interfacial stabilization, the mixture will respond to foam-forming processes such as vigorous agitation or whipping or by other methods familiar in the art, and barrier properties can be readily introduced into the foam. Adding foam-forming substances such as surfactants to the mixture prior to or during the foam-forming process can facilitate foaming due to their ability to stabilize phase interfaces.

Once the foam-forming process is underway and a foam is at least partially formed, the foam-forming formulation can be termed a “foamed material.” A foamed material can be partially foamed and in a fluid state with further foaming to be undertaken, or it can be completely foamed and in a solid or semi-solid state with the foaming process completed. Once the foaming process is underway, by subjecting the foam-forming formulation to processes such as mechanical agitation and/or heating with optional activation of a blowing agent, further methods can be employed to convert the partially formed foam into a fully foamed substance; the term “foamed material” is understood to include both partial and fully foamed states. To convert the partially formed foam into a fully foamed substance, drying methods such as, but not limited to, ordinary baking methods, flash-drying, freeze drying/lyophilization, vacuum drying, and the like can be employed to lock in the foamy texture of the material as the material is dried, so that it retains that structure as it is further processed into formed sheets or formed articles.

Moreover, after the foaming process is initiated or completed, the foam material can be further processed and shaped to yield formed articles of manufacture. As examples, the partially foamed foam material in a relatively fluid state can be extruded as billets and thermoformed into sheets or other useful articles for cleaning purposes. Articles produced from dried foamed material can be equipped with barrier properties embedded in the foam itself, with such properties being customizable to produce advantageous properties (e.g., highly water soluble, or highly water and steam resistant, vapor resistant, and/or oil resistant) for a particular surface-interactive utensil, such as a cleaning utensil. As an example, foamed materials used for cleaning purposes can be tuned to biodegrade after a specified period of time, so that the required shelf life of a given application is matched, and they do not leave residue or plastic waste material when they biodegrade.

In preferred embodiments, an active agent is amalgamated with the foamed material, which the foamed material can transport or deliver to a desired target area. The foam thus can act as a carrier, delivery vehicle, or applicator for the active agent, providing it with access to or contact with the target area, so that the active agent can have the desired effect on the target area. A wide range of active agents are compatible with the foamed materials and articles of manufacture comprising such materials. Articles of manufacture comprising active agents amalgamated into the foamed matrix can be formed as surface-interactive utensils, as described herein.

In a preferred embodiment, such a surface-interactive utensil comprises a cleaning agent or a cleaning formulation as the active agent, and is used as a cleaning utensil. In an embodiment of such a surface-interactive utensil, the foamed material has one or multiple layers of cleaning agents deposited on the surface. In another embodiment, a first foamed material is a water-resistant layer of the cleaning utensil, with a second foamed or non-foamed layer encasing cleaning agents. In yet other embodiments, a first foamed material provides a water-resistant layer of the cleaning utensil, while a second foamed or non-foamed abrasive layer is provided for scrubbing. In embodiments, the foamed material is a water-resistant layer of the cleaning utensil, with a second foamed or non-foamed layer encasing cleaning agents, and a third foamed or non-foamed abrasive layer for scrubbing. In embodiments, the foamed article of manufacture encases, embeds, is coated with, envelops, is layered with, or otherwise integrates or otherwise is amalgamated with one or more active agents; for example a cleaning agent or formulation can be encased within the continuous phase of the foamed material or within the cells of the foamed material, or can be enveloped by the a pocket of foamed material as if contained in a reservoir, or is coated onto or otherwise applied to a surface of the foamed material. In embodiments, the entire article-encasing, embedding, coated with, layered with, or enveloping cleaning agents-is partially or fully water soluble or suspensible, so that the entire article can be used for its intended purpose and then can be safely washed down the drain.

In embodiments, a foamed article of manufacture as disclosed herein can be formed from a foamed composite NCE-containing material whose pre-existing matrix comprises a biopolymer, wherein the additive NCEs optionally provide reinforcement. In a preferred embodiment, the biopolymer in the composite NCE-containing material can comprise polyethylene glycol, and the active agent can comprise a fragrance or a cleaning agent. In an embodiment, an active agent such as a cleaning product can be unit-dosed into a suitably-sized surface-interactive utensil which solubilizes in contact with water, thereby releasing the desired amount of active agent to interact with the target area. Such an embodiment can be useful for both household products and for personal care products, but offers particular advantages for those situations in which accurate dosing is important (e.g., delivering a transdermal dose of a pharmaceutical product, or delivering a pre-measured amount of a skin product such as a sunscreen or dermatological treatment so that the correct amount is distributed over the appropriate skin surface).

Advantageously, foamed materials containing redispersed (or redispersible) NCEs as disclosed herein can be engineered to be less dense than water, so that they float on the surface of an aqueous milieu. Such a material is termed “buoyant” and has buoyant properties. A buoyant cleaning utensil can be desirable for uses in basins of water like dishwashing sinks, to keep the utensil available and to prevent it from disappearing below the surface. However, as noted above, a foamed material can be tuned to biodegrade after a specified period of time, so that they do not leave residue or plastic material even if discarded in a waterway. Optionally, a biobased buoyant article can be treated with an agent such as olivine that absorbs/adsorbs CO₂ from the atmosphere, allowing it to have a beneficial environmental effect during the time before it biodegrades. Simple NCE-based materials can be used for this purpose if their limited longevity and durability is not a significant factor. However, if a longer lifespan for the buoyant foamed particles is desired, composite NCE-containing materials can offer advantages.

In another illustrative embodiment, a foam-forming formulation for producing an OGWR foamed material from a NCE matrix (either simple or composite) can be produced as follows: 1) a population of NCEs can be treated to permit redispersibility as described above, and can be redispersed, as described above; 2) the aqueous solution of the redispersed NCEs can optionally be combined with additional methylcellulose and/or other cellulosics (cellulose esters, ethers, etc.) and/or with a filler or bulking material (for example, without limitation, softwood pulp, hardwood pulp, long fiber pulp, short fiber pulp, Kraft Pulp, SunBurst Pulp, miscanthus, pulps derived from agricultural waste such as soybean, rice hull, or bagasse, fast growing tree species such as eucalyptus, shredded recycled plastics, recycled pulp), optionally shredded and soaked in a liquid blowing agent; 3) a non-aqueous, alcohol (e.g. ethanol) or nonpolar solvent (e.g. acetone) based solution of one or more selected resin acids is prepared, optionally including waxes and other plasticizers (e.g. triglyceride such as corn oil), cellulose acetate and/or other cellulosics and foam-forming substances; 4) non-cellulosic additives such as non-cellulosic thickeners optionally added to increase viscosity (gums like xanthan, guar, locust bean, tamarind, gellan, and the like), and a nucleation agent (such as, but not limited to, calcium carbonate, SiO2, talc, kaolin, SiO2) can also be added to either solution, 5) ethanol optionally can be added to the aqueous solution (to encourage miscibility), and then the alcohol or acetone-based solution are mixed together with the aqueous mixture; 6) ultrafine resin acid particles can be precipitated out of solution, so that they deposit themselves on the surface of the NCEs, or such particles can be prepared via emulsification using PEG and added to the aqueous NCE mixture, producing desirable OGWR properties; 7) the resulting mixture can be foamed as-is, or it can be concentrated or partially or fully dried for transportation to an end-user for later reconstitution and foaming. Foamed materials made from this mixture can be further shaped into formed, foamed articles of manufacture. Foaming of such a mixture can be performed by a number of methods, as described in more detail below.

In one embodiment, two solutions, one aqueous and one predominantly nonpolar, are produced and combined. In the aqueous solution, the redispersed NCEs are mixed with any combination of the following ingredients: an additional dosage of one or multiple cellulose derivatives (e.g., methylcellulose, NaCMC), filler materials (e.g., pulp), nucleating agents (e.g., PCC), surfactants (e.g., capryl glucoside), thickeners (e.g., xanthan gum, guar gum, pectin), plasticizers (e.g., glycerol), and blowing agents (e.g., pentane). If the blowing agent is immiscible with water, the blowing agent can be mixed with something that is miscible with both pentane and water. For example, the addition of ethanol or acetone to pentane enables miscibility between pentane and water. This mixture of pentane and ethanol can be prepared as a 1:1-1:5 ratio of pentane to ethanol. This aqueous solution is viscous enough to trap very fine air bubbles that have been introduced and suspended throughout the solution of redispersed

NCEs and cellulose derivative(s) via medium to high shear mixing. Thus, when the pentane/ethanol mix is added to the solution, the pentane is stimulated to become dispersed throughout the aqueous medium, even though this is not its preferred medium for dispersal. Therefore, pentane is thermodynamically driven to the aforementioned fine air bubbles. These pentane/air bubbles are kinetically arrested by the high viscosity (and slow diffusion) and the polar/nonpolar interactions of the mixture. The uniform distribution and size of these bubbles results in more uniform cells, closed or open, in the final foamed product. The second, predominately nonpolar solution has one or multiple nonpolar solvent (e.g. acetone, ethanol), resin acids (e.g. gum rosin) that will solubilize in the chosen solvent(s), and the option to add one or multiple blowing agents (e.g. pentane), surfactants (e.g. capryl glucoside), nucleating agents (e.g. precipitated calcium carbonate), cellulose derivates-suspended or solubilized (e.g. methylcellulose, cellulose acetate, cellulose acetate butyrate), thickeners (e.g. xanthan, guar, agar) and plasticizers for the resin acids and/or cellulose derivatives (e.g. corn oil, epoxidized soybean oil, triacetin, glycerol, triacetin, acetyl triethyl citrate). The capryl glucoside and ethanol/pentane mix being in either or both solutions helps homogenization when the two solutions are combined via medium to high shear mixing. Once the components are combined, the mixture should be homogenized at high shear. The foams can be heated and/or microwaved to exhibit expansion, and then dried (a number of curing methods, listed above) to lock in the foamed open or closed celled structure.

In another embodiment, rosin or resin acids are in a mixture with a non-polar solvent (ethanol, acetone, methane, and the like) and n-pentane. Other additives, such as one or multiple cellulose derivatives, and a plasticizer, are mixed in. This solution is then mixed with a concentrated or partially or fully dried or concentrated mixture of redispersible NCEs prepared as described herein, and the other potential aforementioned ingredients for the aqueous solution, thereby resuspending the redispersible NCEs. When the rosin/n-pentane solution is mixed with the aqueous NCE resuspension, the rosin and n-pentane form a particulate emulsion of rosin-coated n-pentane embedded in the NCE-containing matrix. The rosin-covered bubbles of n-pentane expand with heating to inflate the NCE-containing matrix.

In yet another embodiment, a non-polar alcohol-based solution is prepared containing rosin or resin acids, stearic acid or other fatty acids, methylcellulose or other cellulose derivative, and a plasticizer such as corn oil. Separately, an aqueous solution is prepared containing a bicarbonate or other foaming agents and the redispersible NCEs prepared as described herein. The two solutions are combined via high-RPM whisking, thereby redispersing the redispersible NCEs. Chemical foaming begins when the two mixtures are combined and whisked, but this foaming can be delayed or modulated by adjusting the amount of water in the system and consequently its viscosity. Rate of foaming can also be modified (accelerated) by heating the system. Foaming can be delayed by embedding the bicarbonate foaming agent in molten wax and crushing the solidified wax-covered bicarbonate before adding it to the solution: under these circumstances, the wax will melt and release the foaming agent into the solution to effect bubble formation. Foaming can also be delayed by adding solid stearic acid to the solution with subsequent heating of the solution so that the stearic acid melts and enters the solution, thereby encountering and reacting with the bicarbonate.

In still another embodiment, an aqueous emulsion of methylcellulose is formed at high shear, optionally adding ethanol to the emulsion to speed up the emulsification of the methylcellulose. A blowing agent such as n-pentane can be added to the emulsion. A concentrated or partially or fully dried suspension of redispersible NCEs (prepared as described herein) is then mixed into an aqueous medium, thereby redispersing the redispersible NCEs. Separately, a fully dissolved solution of rosin or other resin acid(s) in alcohol is prepared. This solution is added at high shear to the aqueous mixture containing the redispersed NCEs. To foam this mixture, heat can be employed, using heat sources such as oven heating (40-150° C.), microwaving, steaming, and the like.

Other orders of addition for the ingredients can be employed besides those already described. In one embodiment, cellulose acetate is dissolved in acetone, with the subsequent addition of stearic acid. Separately, rosin or other resin acid(s), oil as a plasticizer, and acetone are combined. In a third container, a concentrated or partially or fully dried mixture of redispersible NCEs (prepared as described herein) is combined with the bicarbonate in an aqueous suspension, thereby redispersing the redispersible NCEs. The rosin-containing solution and the NCE-containing mixture are combined, and the cellulose acetate-containing solution is then added in. In another practice of the invention, stearic acid is dissolved in ethanol. Separately, ethanol, rosin or other resin acid(s), a plasticizer such as an oil, and methylcellulose are combined. In a third container, a concentrated or partially or fully dried mixture of redispersible NCEs (prepared as described herein) is combined with the bicarbonate in an aqueous suspension, thereby redispersing the redispersible NCEs. The rosin-containing solution and the NCE-containing suspension are mixed, and the stearic acid-containing solution is added to that mixture. Additional water can be added if needed to incite the bicarbonate/acid gas-forming reaction, and thickeners (e.g., xanthan, guar, agar, gellan, and the like) can be added to slow the diffusion rate of gas through the sample.

In yet another embodiment, an acetone-based solution is loaded with a nucleating agent, then a resin acid (such as gum rosin) and a cellulosic polymer such as cellulose acetate (or CTA, CAB, CAP, or CAPh) are dissolved in the solution, followed by the addition of a blowing agent (e.g. pentane), and either a solution of redispersed NCEs is added or a quantum of dried, shredded, redispersible NCEs which thereupon become redispersed. Before the addition of the NCEs, there is the option to add to either/both solution(s), a surfactant, another cellulose derivative (for example, suspending a water-soluble cellulose derivative in the acetone solution that will thicken upon addition to the potentially aqueous solution of redispersed NCEs), a fatty acid, and/or a thickener (e.g., xanthan gum).

In each case, after the foam-forming formulation is prepared, it can be heated, for example in an oven such as a convection oven or vacuum oven, at a range of temperatures depending on the formulation (50-120 degrees° C.) to expand and then solidify the foam, starting the thermosetting process, without getting too hot that the formulation melts or thermally degrades. The heat, especially when provided by hot air, will create a solid film on top of the foam. Once this film has set and the sample is mostly but not completely dry, the sample can be microwaved for about 3-120 seconds (depending on wattage and liquid concentrations in the formulation), preferably in a perforated vessel to avoid steam explosions, and then optionally quenched (rapidly cooled) or placed back in the oven to set the expanded structure. Alternatively, the sample could be extruded, quenched, and sublimated or extruded and baked. Upon heating, a temperature gradient is formed across the sample. Therefore, the high vapor-pressure solvents evaporate faster at the surface, allowing the rosin or resin acid component of the formulation to supersaturate the surface and nucleate there, creating a hydrophobic, sealed outer layer to the solid foam article. For applications where rigorous hydrophobicity is required, an additional spray on coating (of, for example, without limitation, cellulose acetate and rosin) can be added to the sample before or after molding.

In formulations that include fatty acids, these substances can melt upon heating and interact directly with bicarbonate to release CO₂. If the bicarbonate has been embedded in wax, heating can melt the wax and release the bicarbonate, thus starting the gas-forming reaction. CO₂ that is released can become entrapped by the rosin or resin acid(s) in the formulation, or by matrix components including the NCEs, increasing foam volume. As the formulation cools, the viscosity of the rosin increases, solidifying the foam and trapping the CO₂ in the matrix; quenching (with the option, if needed, to sublimate any trapped water) can also achieve this effect.

Without being bound by theory, it is understood that the presence of a water-resistant barrier formulation within and around the foam in the foamed article can have a protective effect so that the redispersed (or redispersible) NCEs within the foam are protected from encountering water. It is envisioned that the redispersed (or redispersible) NCEs within the foam solidify into a simple NCE-based matrix or a composite NCE-containing matrix (as applicable) within which the presence of a drying/dispersal additive could permit subsequent or initial (as applicable) NCE redispersion in the presence of water, a situation that could weaken or erode the overall foam structure. The water-resistant barrier formulation insulates the foam from contact with water, thereby preventing the encounter of the redispersed (or redispersible) NCEs with water and thus at least partially restricting their subsequent redispersibility, thus protecting the integrity of the solid foamed structure comprising said redispersed (or redispersible) NCEs.

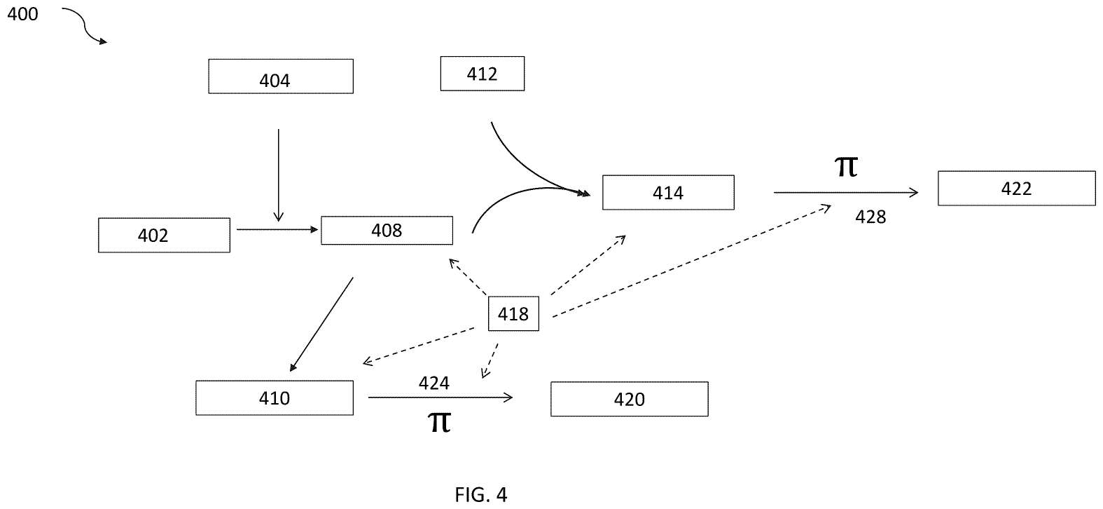

An exemplary process for forming a foamed material from a simple NCE-based matrix or a composite NCE-containing matrix is shown schematically in the block diagram of FIG. 4. The process 400 in FIG. 4 begins with providing a dried material 402 containing redispersible NCEs, where such dried material has been prepared substantially as described in connection with FIG. 1. The dried material 402 is then treated with a resuspending fluid 404 to resuspend the NCEs in the dried material and to form a suspension of redispersed NCEs 408, substantially as described in connection with FIG. 1. The suspension of redispersed NCEs 408 can then be processed as a simple NCE-based matrix 410, or can be combined with a pre-existing matrix 412 to form a composite NCE-containing matrix 414, substantially as described above in connection with FIG. 2 and FIG. 3.

Foam-forming substances 418 can be added to any of these substances (the suspension of redispersed NCEs 408, the simple NCE-based matrix 410, or the composite NCE-containing matrix 414) in order to initiate foam forming within the substance, or in order to prepare the substance for further foam-forming processes. Foam-forming substances are familiar in the field, and can include: surfactants (nonionic, anionic, cationic, amphoteric) and chemicals that reduce the surface tension of the medium, thus reducing the work needed to create the foam. Foam-forming substances agents include, without limitation, chemicals such as glucosides (e.g., capryl, caprylic, lauryl, coco, decyl, etc.) which also help homogenize polar and nonpolar solutions, SLS (sodium lauryl sarcosinate), SCI (sodium cocoyl isethionate), SDS (sodium dodecyl sulfate), SMCT (sodium methyl cocoyl taurate), SOS (sodium cocoyl sulfate), SCS (sodium caprylyl sulfonate).

In embodiments, foam-forming substances can include gas-producing reagents which form gas that is then trapped within the supporting medium for the foam; this gas trapping creates the foam. Such reagents can decompose or vaporize easily at given temperatures to produce gases or vapors. In other embodiments, foam-forming substances can include two-reactant systems in which two reactants combine to yield a gaseous product; typically, one reagent (the gas producer) reacts with another chemical, resulting in the production of CO₂ or another foam-forming gas from the gas producer. When such substances are incorporated into a precursor material for forming a foam, they can be used to produce a closed-cell structure by decomposing within the precursor material and releasing gas bubbles that are trapped during the solidification of the precursor material to form the foam. Such foam-forming substances can be termed blowing agents, specifically chemical blowing agents because they produce gases and foaming through chemical changes or reactions.

Chemical blowing agents such as calcium bicarbonate or sodium bicarbonate are gas-producing reagents that can be added to the foam-forming formulation and exposed to an acidic environment to release CO₂ gas into the supporting medium. Calcium bicarbonate is advantageous because it is environmentally green and has low solubility in a foam-forming formulation, and thus tends to form numerous and fine gas bubbles when exposed to acid; such bubbles tend to form a closed cell foam that has greater resistance to oil or water incursion. In embodiments, a carboxylic acid can be included in the formulation to provide the acidification needed to release the CO₂ from the gas-producing reagent. Carboxylic acids selected for this purpose can be derived from bio-based sources, such as fatty acids, e.g., stearic acid, oleic acid, and the like. The long aliphatic tail on fatty acids enhances their compatibility with other components of the foaming mixture. Other chemical blowing agents include, without limitation, isocyanate and water, azodicarbonamide, and hydrazine.

In other embodiments, foam-forming substances include inert gases that are introduced under pressure into a precursor material for forming a foam without any chemical change or reactivity: instead, they form a foam by expanding within the precursor material. The resultant diffusion of the inert gas through the precursor material generally produces an open-cell foam as the pressurized gas penetrates the precursor material to reach the outside environment. Such foam-forming substances can also be termed blowing agents, specifically physical blowing agents because are already in their final chemical state as inert gases and they form the foam by expanding within the precursor material as a result of temperature or pressure differentials. Examples of physical blowing agents include, without limitation, H2O, liquid, carbon dioxide, supercritical carbon dioxide, hydrocarbons (e.g., n-pentane, isopentane, cyclopentane) hydrochlorofluorocarbons, chlorofluorocarbons. A mix of chemical and physical blowing agents can be used to tailor expansion in the foam and to avoid thermal degradation of the system.

As is known in the foam art, blowing agents can be added to or dissolved (temperature and pressure dependent) in a foam-forming formulation to cause bubbles to nucleate, grow, and stabilize therein. The small gaseous pockets created by the blowing agent can then expand under different conditions such as heat or pressure, and can be stabilized with certain additives (e.g., viscosifiers, electrostatic stabilizers) or by kinetically arresting diffusion of the gas with quenching or heat curing. N-pentane is a blowing agent familiar in the foaming field because of its widespread use in forming foamed polystyrene beads. Many other blowing agents are available for use with the formulations disclosed herein that can produce the desired amount of gas bubble expansion at the desired temperature for foaming.

As shown in FIG. 4, the simple NCE-based matrix 410 and the composite NCE-containing matrix can be further processed to produce, respectively, a simple NCE-based material 420 or a composite NCE-containing material 420. As described in connection with FIG. 1, a simple NCE-based material is understood to comprise a simple NCE-based matrix, wherein the simple NCE-based matrix provides the architectural framework for the material, and to further comprise any other additive substances. Similarly, as described in connection with FIG. 1, a composite NCE-containing material is understood to comprise a composite NCE-containing matrix, wherein the composite NCE-containing matrix provides the architectural framework for the material, and to further comprise any other additive substances. As shown in FIG. 4, either matrix alone or materials formed therefrom can act as substrates for foaming.

As mentioned above, FIG. 4 shows foam-forming substances 418 being optionally introduced into the suspension of redispersed NCEs 408, and/or into the simple NCE-based matrix 410, where the presence of these additives can initiate foaming or prepare the substance for further foam-foaming processes; FIG. 4 further shows foam-forming substances 418 being introduced as the simple NCE-based matrix 410 is processed to form the simple NCE-based material, and as the composite NCE-containing matrix 414 is processed to form the composite NCE-containing material 422; FIG. 4 also shows foam-forming substances 418 being optionally introduced into the composite NCE-containing matrix 414. Also optionally, but not shown in FIG. 4, foam-forming substances can be introduced into the pre-existing matrix 412. The Figure depicts the transition from matrix to material as a strategic site for foaming, either as part of the processing step 424 from simple NCE-based matrix to simple NCE-based material, or as part of the processing step 428 from composite NCE-containing matrix to composite NCE-containing material.

Besides these options for foaming due to the action of the foam-forming substances, foaming can also be produced in a simple NCE-based material matrix or material or a composite NCE-containing matrix or material by the action of foam-forming processes in addition to or as an alternative to the action of foam-forming substances. Sites for preferred action of foam-forming processes for producing foams are indicated in FIG. 4 by the symbol TT. Foam-forming processes include, without limitation: high RPM mixing (“whipping”) or lower RPM mixing (“stirring”) to physically incorporate air; high to low pressure extrusion; sublimation; exposure to electromagnetic radiation (such as microwaves) to create pores from exciting solvent molecules; and time- and temperature-dependent heating, quenching, and/or freeze drying. These methods can be combined and/or cycled through to achieve the desired foam consistency, density, stiffness, and pore size. In embodiments, mechanical methods are especially advantageous as one of the later stages of the process 400 shown in FIG. 4.

In either case, the NCE-containing material, whether it is a matrix formed predominantly from the NCEs or whether it is a composite containing NCEs as an additive to another substrate, can be mixed, aerated, or treated otherwise to create a foam. Components of the foam-forming formulations disclosed herein include the redispersed or redispersible NCEs with or without other matrix materials, and can include a foaming or blowing agent, with or without undergoing a foam-forming process. Foam-forming processes include, without limitation, heating the formulation, changing pressurization, sublimation, mechanical whipping, and the like. Active agents can be optionally added for special purposes, as described below. In embodiments, the foamed material can be formulated for a specific purpose such as cleaning purposes by including one or any combination of the following additives: a population of redispersible NCEs formulated with one or more dispersal additives as described herein, a task-specific cleaning agent, organic filler, biomass filler, inorganic filler, pulp, thickeners, blowing and/or foaming agents, nucleation agents, surfactants, crosslinking agents, barrier-producing additives, and curing agents. In embodiments, the NCE-containing cleaning formulation further comprises one or more additives selected from the group consisting of a foaming agent, an additive to manage water hardness, an antimicrobial agent, a disinfectant, a secondary cleaning substance, a colorant, a fragrance, a chelator, and a foam stabilizer. Performance-altering additives, e.g., for imparting oil, grease, and water resistance, can be incorporated as barrier treatments, as described below. The mixture of redispersed (or redispersible) NCEs, active agents and performance-altering additives can then be mixed vigorously; in embodiments, sufficient mixing can be applied so that the mixture is aerated into a foam.

In embodiments where further strength, durability, or wet strength is desired, crosslinking beyond hydrogen bonding can be achieved by adding mono- or preferably, di- or multi-carboxylic acids. In embodiments, the crosslinking can occur between a hydroxyl group (for example, of an NCE) and a carboxylic acid (such as but not limited to citric acid, succinic acid, adipic acid, fumaric acid, malic acid, maleic acid, acrylic acid, glutaric acid, and butanetetracarboxylic acid. In embodiments, the crosslinking agent can also be one or a combination of ionic polymers, such as cationic starch, chitosan, NaCMC, and the like.

In embodiments, a composite matrix produced using biodegradable materials as the pre-existing matrix is especially suitable for foaming and for producing foamed articles of manufacture, such as cleaning utensils. Foamed products made from biodegradable materials, for example foams formed from starches, can have poor performance relative to petroleum-derived foams, often lacking the strength and water/grease resistance of petroleum-derived products. NCE-based foams, derived predominantly from NCE matrices, can act as substitutes for conventional foams for uses in common articles of manufacture, as described herein. Composite materials, comprising mixtures of NCEs and biodegradable materials such as starches or derivatized cellulose (e.g., cellulose ethers or cellulose acetate), can also be prepared as foamed articles and can be similarly used as substitutes for conventional foams, combining the advantages of biodegradability with the desirable strength, absorbency, durability, variable abrasiveness, easy rinsing and quick drying, tunable reusability, and chemical compatibility that cleaning utensils require in different settings.

For composite NCE-containing materials comprising starch as the pre-existing matrix, cellulose microfibers are advantageous, either alone or in combination with cellulose nanofibers. Composite materials can also comprise pulp-based matrices or starch-pulp matrices, forming all-cellulose composite NCE-containing materials. Foaming of composite matrices incorporating NCEs can be produced by a number of methods familiar in the art and previously described, such as mechanical foaming techniques, by incorporating foam-forming elements such as surfactants or blowing agents in the mixture. As an example, bicarbonate crystals can also be incorporated into the mixture as a foam forming element with a later addition of acid to activate foaming. Additives such as linseed oil or more hydrophobic cellulose additives, such as methyl cellulose, cellulose acetate, lipids, polyvinyl alcohol or copolymers of polyvinyl acetate/polyvinyl alcohol, waxes, wax emulsions hydrophobic starch, fatty acids, resins, other hydrophobic cellulosic polymers, or any other similar hydrophobic polymers can be added to improve hydrophobicity; alternatively or in addition, the NCE additives can be prepared having OGR properties. In some embodiments, chitosan and aluminum sulfate are used to enhance OGR. In other embodiments, celluloses and cellulose derived materials with high hydroxyl content can be used for OGR. To tune the mechanical properties of the foam, additives such as, but not limited to, plasticizers for tunable plasticity (for example, but not limited to, polyols like glycerol) viscosifiers or thickeners (e.g. xanthan gum, guar gum, and the like), flame retardants (for example, without limitation, metal hydroxides such as aluminum trihydrate (ATH) and magnesium hydroxide, halogenated compounds (e.g., brominated species that allow resins to retain their mechanical properties), and polydopamine), and nucleating agents such as but not limited to minerals (e.g. precipitate calcium carbonate, silicone dioxide) to tune foam pore size and density. As mentioned previously, plasticizers, filler particles, film-forming biopolymers, and other additives can be added to the NCE matrices (either simple or composite) to form analogous materials (either simple or composite). Foamed formulations intended for use as cleaning products can further comprise one or more additives selected from the group consisting of a foaming agent, an additive to manage water hardness, an antimicrobial agent, a secondary cleaning substance, a colorant, and a fragrance.

For those materials intended for foaming, additives can be selected that are compatible with the formation and maintenance of the foam. Examples of such reagents include, without limitation:
Fatty acids (e.g., stearic acid)
Alcohols, e.g., methanol and ethanol
Acetone
Resin acids
Natural resins such as camphor, turpentine, dammar gum, shellac and the like
Fat-soluble vitamins (A, D, E, K)
Mineral powders such as titanium dioxide, talcum powder, calcium carbonate, silica, titanium dioxide, and the like
Starches such as corn starch
Selected rubbers and elastomers

### b. Exemplary Foamed Articles of Manufacture

In certain aspects, the surface-interactive utensil is foamed or comprises a foamed material, wherein the utensil comprises a simple NCE-based matrix comprising redispersed or redispersible NCEs or a composite NCE-containing matrix comprising redispersed or redispersible NCEs and wherein the utensil optionally further comprises a cleaning agent; wherein the redispersible NCEs are prepared by partially or completely drying a liquid formulation, wherein the liquid formulation comprises a suspension of nanocellulose elements (NCEs) in a liquid medium and a drying/dispersal additive; wherein the redispersed NCEs are prepared by suspending the redispersible NCEs in a resuspending fluid; and wherein the drying/dispersal additive is a LCST polymer such as methyl cellulose and the like, for example, from 1-50 dry weight (dwt) % or 10-40 dwt %. In certain aspects, the surface-interactive utensil comprises an LCST polymer such as methyl cellulose and the like, for example, from 1-50 dry weight (dwt) % or 10-40 dwt %. In additional aspects, the surface-interactive utensil is foamed or comprises a foamed material, wherein the utensil comprises a simple NCE-based matrix comprising redispersed or redispersible NCEs or a composite NCE-containing matrix comprising redispersed or redispersible NCEs as described herein, and wherein the utensil optionally further comprises a cleaning agent, wherein the NCEs are nano- and/or micro-fibrillated cellulose, for example, from 2-80 dwt % or 5-40 dwt %. In certain specific aspects, the drying/dispersal additive is an LCST polymer such as methyl cellulose and the like, from 1-50 dry weight (dwt) % or 10-dwt %, and the NCE is a nano- and/or micro-fibrillated cellulose, from 2-80 dwt % or 5-40 dwt %. The utensil can further comprise a thickener such as xanthan gum and the like, for example, from 1-30 dwt % or 5-25 dwt %; a surfactant and/or foaming agent such as capryl glucoside and the like, for example, from 0.05-5 dwt %; and/or ethanol (pentane compatibilization agent) and pentane (blowing agent), for example, in a one-one ratio from 0.2-wet wt % or 10-100 dwt %. The use of pentane and ethanol can be avoided in water soluble foam applications, in which the water used for formulating is also utilized as the blowing agent. In certain aspects, the utensil further comprises a filler such as pulp, for example, from 0-80 dwt %; a nucleation agent such as precipitated calcium carbonate and the like, for example, from 0.5%-25 dwt %; and a hydrophobic barrier additive such as gum rosin, for example, from 0.5-50 dwt % or 10-40 dwt % (which can be added to the aqueous suspension as a solution in ethanol or a PEG stabilized emulsion in water). The cleaning agent can, for example, be combined with the aqueous suspension or resuspension of micro- and nano-FCs, an LCST polymer, such as (without limitation) MC, CMC, HPMC, or NaCMC, and other additives. The cleaning agent can also be coated onto the surface of the formulation before, after, or during drying. Dry cleaning agents such as powders can be suspended or dissolved into the aqueous suspension, or bound to the surface of the article before, during, or after drying. The loading of the cleaning agent to foam by weight can, for example, range from 1:19-19:1.

Appropriately engineered simple NCE-based matrices or materials or composite NCE-containing matrices or materials as described herein can be readily transformed into foamed materials in liquid or solid state that can be dried or otherwise shaped into articles of manufacture, producing surface-interactive utensils that substitute for conventional utensils for surface-interactive purposes. As an illustration, cleaning utensils produced by the methods disclosed herein can substitute for conventional cleaning articles. Exemplary cleaning tasks for such substitute utensils can include household uses such as bath and shower cleaning, oven cleaning, glass cleaning, dishwashing and cooking equipment cleaning, and disinfection, as well as personal care uses. Such substitute utensils can also be used for professional cleaning tasks in a variety of settings in health care, industry, and commerce. Using readily available brands of cleaning products and technologies for embedding soaps and laundry products into simple NCE-based or composite NCE-containing matrices, as set forth in U.S. patent application Ser. No. 17/896,375, the contents of which are incorporated herein by reference, cleaning agents or cleaning formulations (i.e., a formulation comprising a cleaning agent) can be combined with the NCE redispersion technology disclosed herein, with the inclusion of cleaning substance active agents in the foam sponge itself or in utensils that comprise the foam sponge. In the disclosure below, surface-interactive utensils dimensionally and functionally adapted for carrying out cleaning tasks, whether for household purposes or personal care purposes, (such utensils collectively being termed “cleaning utensils”) are described in detail as non-limiting examples of the present invention.

For the purposes of this disclosure, both cleaning agents and cleaning formulations are active agents that are embraced by the term “cleaning substance.” Conventional cleaning substances can include a variety of primary and secondary cleaning agents such as, without limitation, soaps and detergents, all-purpose cleaners, disinfectants, fragrances, deodorizing agents, glass cleaners, stainless steel cleaners, abrasive cleaners, bleaches, and the like. In embodiments, a cleaning substance active agent can comprise a conventional cleaning agent or formulation. In embodiments, a cleaning substance can comprise a specially formulated combination of ingredients such as the NCE-containing cleaning formulation, as described below in more detail.

As used herein, the term “cleaning agent” can refer to a material such as a soap or a detergent, i.e., a substance that has the ability to remove dirt from surfaces (considered “primary cleaning agents”) and can also refer to a material that is useful for adjunctive cleaning and disinfecting purposes, such as antiviral or antibacterial agents, deodorants, fragrances, and the like (which are considered “secondary cleaning agents”). Cleaning agents for inclusion in the foamed cleaning utensils described herein can include primary or secondary cleaning agents and combinations thereof. As used herein, the term “cleaning formulation” refers to a cleaning agent in combination with one or more other materials; such other materials can have cleaning functionality but can also be inert or can have non-cleaning functionalities. Cleaning agents and cleaning formulations are useful in conjunction with surface-interactive utensils comprising absorbent materials, applicator materials, or abrasive materials and combinations thereof.

Certain materials designed to mechanically remove adherent dirt from surfaces are a species of abrasive materials referred to herein as “scrubbing materials.” In contrast to materials or articles including cleaning agents, a scrubbing material accomplishes its cleaning task mechanically, by abrading, loosening, lifting, scraping, or otherwise physically removing or detaching undesirable adherent substances from the surface being cleaned. A scrubbing material typically is formed, shaped, or otherwise produced so that it has abrasive properties to remove crusted-on dirt or other undesirable substances attached to or produced on a surface. A scrubbing material having mechanical properties such as toughness and abrasiveness can be made from NFC-containing foams, conventional foams, NFC-containing sheets or nonwoven materials, conventional sheets or nonwoven materials, or other substrates familiar to skilled artisans. Cleaning a surface can be performed with the scrubbing material instead of or in addition to delivering cleaning agents to the surface.

In embodiments, scrubbing materials can be combined with softer foam materials in composite cleaning utensils that provide two surfaces, an abrasive one for scrubbing purposes and a softer one to dispense and apply cleaning agents. For example, sponges with two different types or consistencies of foam or other textured surfaces are advantageous for use in the cleaning utensils described herein because they can combine the benefits and properties of both types of foams or other textured surfaces, providing enhanced cleaning capabilities and versatility. A scrubbing material, whether foamed or non-foamed, having mechanical properties and textures suitable for scrubbing can be attached to a softer sponge for gentle cleaning.

Both the external surface of the scrubbing material and the external surface of the cleaning foam can be used to accomplish the designated task of the cleaning utensil. These two different types of cleaning surfaces can serve distinct functions, such as gentle cleaning on one side (with the soft foam) and scrubbing on the other side, or more absorbency on one side and more abrasiveness on the other. A softer foam with more absorbency can be used on delicate surfaces such as glass, stainless steel and non-stick cookware, while the abrasive side can be used for more challenging tasks such as scrubbing crusted grime off surfaces or removing stubborn stains. Cleaning utensils made from sponges comprising different types of foam with different properties allow the user to change from one set of cleaning attributes to another using the same device, instead of switching from one utensil to another. Multi-purpose sponges can include different types of foams having different densities, textures, or absorbencies, or different degrees of abrasiveness; in embodiments they can incorporate specialized additives such as abrasive particles or microfiber on one of their surfaces.

The concentration of NCEs in the substrate to be foamed can be adjusted to produce appropriate mechanical properties and barrier properties in the final foamed material. For example, the amount of NCEs in the substrate can be varied to attain a softer foam or a stiffer foam. While the general range of NCEs in the final substrate is about 1 to about 10%, for softer foams and about 20% to about 50% for stiffer foams, a very soft foam can include as little as 0.1 wt % and a foam for construction materials can include up to about 90 wt %. Varying the consistency of the foam can permit articles to be designed for specific uses. Furthermore, combining foams of different types and consistencies can allow cleaning utensils to be designed for specific purposes.

In more detail, foams formed from simple NCE-based matrices or materials, or composite NCE-containing matrices or materials can be used in single-purpose or multipurpose sponges or other cleaning utensils, with or without other, specialized additives. Single-purpose absorbent articles of manufacture such as sponges can be formed from foams having selected densities, textures, and absorbencies, and multi-purpose sponges can be formed, for example having two different types of foams (e.g., a soft foam and a firmer foam) for different sorts of cleaning tasks. Single-purpose absorbent materials such as sponges or applicator materials such as wipes can be equipped with abrasive additives if they are to be used for heavy-duty cleaning tasks that include scrubbing; such abrasives can be distributed throughout the foam or sequestered in certain areas of the foam. Composite utensils are also envisioned, in which a foamed domain provides absorbency or allows application of the active agent to the surface, and a non-foamed region is available to perform abrasive functions such as scrubbing.

Multipurpose surface-interactive utensils can be made of different foam types to accomplish different tasks (e.g., cleaning tasks), with abrasive additives incorporated in one or more of the different foam types, or abrasive additives included in a discrete, non-foamed layer. Instead of or in addition to adding abrasives, an external layer for such a utensil can be equipped with various arrangements of fibers on its surface, for example aligned fibers that could produce corrugations or other uneven areas, allowing a rougher surface with multiple contact points for abrading areas to be cleaned or otherwise treated. In embodiments, a stronger foam can be used to support such an uneven surface, with a softer foam on a different aspect of the sponge that lacks the uneven arrangements. In embodiments, a layered product can be formed having a tougher side that is formed from a foam having a higher concentration of NCEs or other durability/strength-enhancing additives. Because of the variability that can be engineered into the foam types, and the combinations that can be envisioned with foamed and non-foamed components, utensils can be designed with degrees of durability that match their intended uses. For example, special purpose sponges can be produced for heavy-duty jobs that include absorbency like cleaning up oil and grease, and optionally can be designed to absorb oily materials in addition to or instead of aqueous materials. As another example, special purpose pads can be made from elongated compressed foam or closed cell foam to enhance their strength and durability.

For other uses, surface-interactive utensils or components thereof can be engineered to dissolve readily upon contact with water, or to resist dissolving to varying extents. A surface-interactive utensil designed for a single use, such as a toilet brush, can be engineered as an absorbent article or an applicator article to dissolve fairly quickly upon contact with water so that it does not need to be discarded; it can also include areas for abrasive activity such as scrubbing. Such a utensil can be employed for a specific task, like cleaning and/or sanitizing a toilet bowl, and then can be left simply to dissolve over a short period of time, leaving no residue behind. Multipurpose surface-interactive utensils designed for multiple uses can be made of more durable materials so that they retain their integrity after one or more uses. Surface-interactive utensils can also combine a durable component and a dissolvable component, such as a durable applicator handle for a toilet bowl cleaning article that holds a replaceable cleaning component pad, such as an applicator for cleaning products that dissolves fairly quickly upon contact with water so that it does not need to be removed and discarded.

As illustrated by these examples, surface-interactive utensils, such as cleaning utensils, comprising simple NCE-based matrices or materials or composite NCE-containing matrices or materials can be engineered specifically to meet the requirements that accompany a specific task, such as a cleaning task. For example, the foamed material can be shaped as a formed article in a form suitable for use with an active agent such as a cleaning substance, thereby rendering the formed article suitable for that specific cleaning task. Simple NCE-based materials and composite NCE-containing materials have specific mechanical properties due to their incorporation of the NCEs themselves in a structural framework, and due to the propensity of the NCEs within the structural material to become re-redispersed, so that the material loses the mechanical integrity that the NCE-based or NCE-containing material provides. As mentioned above, the presence of water-resistant barrier formulations can add protection to the NCE-based or NCE-containing material to protect it as needed from encountering water that could dissolve or weaken it.

In embodiments, NCE-based or NCE-containing foamed materials can be engineered to be dissolved at a specific rate to produce a timed release of an active agent embedded in the material or enveloped by it. Such a material can be primed for a particular release profile, for example, by decreasing crystallinity of the foam (lower crystallinity corresponds to faster dissolution), using limited or no hydrophobic additives, and optimizing the plasticizer concentration at higher levels to promote faster dissolution (higher concentration leads to faster dissolution). As an example, the active agent, such as a cleaning substance, can be embedded in the pores of the prospective surface-interactive utensil sponge by loading it into the nonpolar phase that includes the blowing agent. In this context, the active agent, such as a cleaning substance, can be formulated for timed release of the relevant additives, allowing the wearing of the utensil to match the consumption of the additives over time. Foams, as compared to bulk materials, are likely to dissolve faster since more surface area is exposed, allowing foams advantages in contexts where dissolvability is desired.

In exemplary embodiments, surface-interactive utensils or materials, such as absorbent articles or materials (e.g., sponges) and applicator articles or materials (e.g., cleaning pads), and related articles or materials such as scouring pads can optionally be equipped with embedded, coated, layered or embedded with active agents such as cleaning agents, or can envelop them within their substance. In such exemplary, non-limiting embodiments, such a utensil or material, intended for cleaning purposes, can provide an all-in-one solution to a given cleaning task without having to add cleaning substances to the utensil or material in order to accomplish the task. In such an embodiment, cleaning substances can be integrated into the foam used to form the cleaning utensil or material or can be otherwise introduced into or amalgamated within the interstices of a cleaning pad or scouring pad.

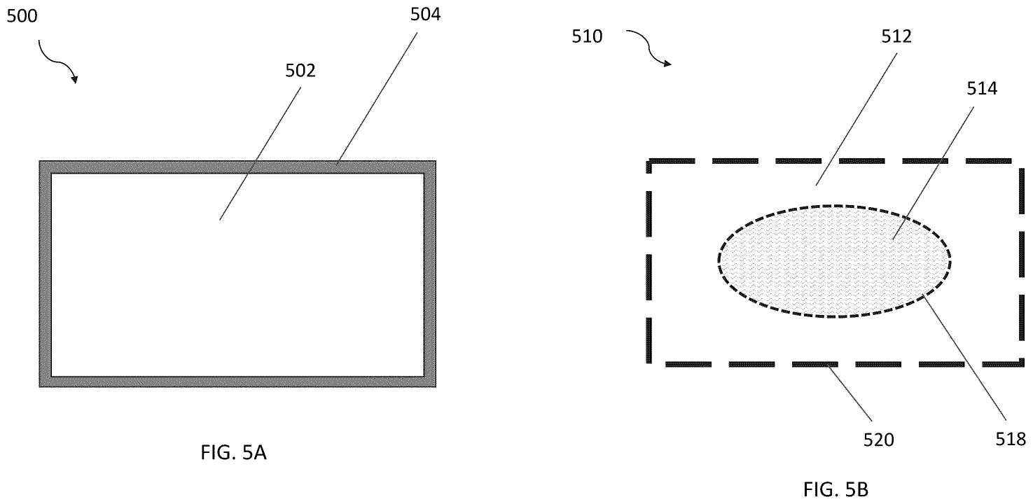

FIGS. 5A and 5B illustrate embodiments of surface-interactive utensils in which a surface-interactive foamed material is surrounded by a layer of an active agent (FIG. 5A), or embodiments of surface-interactive utensils formed to contain a repository within its substance that can hold the active agent. Such surface-interactive utensils can be used for a variety of purposes, for example cleaning purposes, as described below.

Consistent with the depiction of FIGS. 5A and 5B, an exemplary surface-interactive utensil can be used for cleaning purposes. In such an embodiment, a surface-interactive utensil, such as an absorbent article for cleaning purposes (e.g., a cleaning sponge) can be surrounded by a layer of a cleaning substance and/or scrubbing material on its outside, as shown in FIG. 5A. In other embodiments, such a surface-interactive utensil can be formed to contain a repository within it that can hold active agents such as cleaning substances, as shown in FIG. 5B. For example, a cavity can be formed within the utensil to retains the cleaning substance, or the foamed utensil can be formed around a dissolvable shell that contains the cleaning substance so that the substance is released when the foam is penetrated by water. In yet other embodiments, the surface-interactive utensil for cleaning purposes is formed by initially drying (partially or completely) a foamed material and forming a dried formed foamed article therefrom; exposing the dried formed foamed article (e.g., a foam sponge) to an active agent (e.g., a cleaning substance), so that the formed foamed article is amalgamated with the active agent, for example by imbibing the active agent into its interior or becoming partially encased in the active agent, thereby forming a foamed article bearing the active agent; and secondarily drying this foamed article, thereby drying both the active agent and the foamed material, producing a surface-interactive utensil that is a finished foamed article bearing the active agent.

FIG. 5A depicts schematically a cross-section of an embodiment of surface-interactive utensil consistent with the principles of the invention that is formed as a sponge for cleaning purposes or for other purposes. As shown in the Figure, an embodiment of a surface-interactive utensil 500 such as a cleaning utensil can have a foamed material shaped to form spongy inner core 502 and can have a surrounding layer of an active agent such as a cleaning substance and/or scrubbing material 504. The spongy inner core 502 can be made of one or more NFC-containing foam layers formed as described above. Active agents, for example cleaning substances (either conventional formulations or NCE-containing cleaning formulations as described in more detail below), can be deployed within the interstices of the foam layers that form the spongy inner core 502. Surrounding the spongy inner core 502 is a layer of an active agent 504, such as a cleaning substance and/or scrubbing material, which can be affixed more or less durably to the spongy inner core 502. Either the spongy inner core 502 or the outer layer of the active agent 504, such as a cleaning substance or scrubbing material, or both the core 502 and the outer layer 504 can contain a variety of active agents, for example (without limitation) cleaning substances such as (w, soaps and detergents, all-purpose cleaners, disinfectants, fragrances, deodorizing agents, glass cleaners, stainless steel cleaners, abrasive cleaners, bleaches, and the like. In embodiments, these active agents (such as cleaning substances) are dried in place, but can be activated upon contact with water. An active agent (e.g., a cleaning substance) that forms the outer layer 504 can itself contain abrasives or other substances that facilitate dirt removal, or it can be relatively soft to protect surfaces that are being cleaned, or some combination thereof.

The outer layer of active agent 504 (e.g., cleaning or scrubbing material) can be relatively durable, permitting multiple uses. For single use purposes, the user can wet the surface-interactive utensil 500 and use all the active agent in the utensil 500 for that one job. If less than the full amount of an active agent is required for a particular task, the user can allow the utensil 500 to dry and then rewet it to activate it when needed again. This arrangement, useful for a variety of active agents, is particularly advantageous for cleaning utensils that can be used repeatedly for routine household tasks (such as kitchen cleaning), or for more specific commercial or industrial applications.

Whether or not the outer layer 504 itself contains active agents, a reservoir of the same or different active agents can be carried within the spongy inner core 502 and released upon contact with water to pass through the spongy inner core 502 and reach the outer surface of the outer layer 504, thus being delivered to the surface to be treated. In embodiments, the outer layer 504 has different properties in different regions, for example having an abrasive side and a smooth side. In embodiments, this abrasive material has different mechanical properties than the spongy material used to form the substance of the utensil 500. This will allow the surface-interactive utensil 500 to accomplish several different tasks, depending on which side of the utensil is being used. In an exemplary surface-interactive utensil used for cleaning purposes, for example, the abrasive side can be used to dislodge crusted food remnants from a cooking pot, after which the smoother side can be used to complete the overall cleaning of the article. Using the methods described above, all the components of the surface-interactive utensil 500 can be made from foams formed from simple NCE-based matrices or materials or composite NCE-containing matrices or materials.

FIG. 5B depicts schematically a cross-section of an embodiment of a surface-interactive utensil, such as a cleaning utensil, consistent with the principles of the invention. As shown in the Figure, an embodiment of a surface-interactive utensil 510 can have a spongy foam layer 512 enclosing an inner deposit 514 of an active agent, such as a cleaning substance. The inner deposit 514 can be surrounded by an optional membrane that is semipermeable to water or is partially or fully dissolvable in water 518. This layer 518 can hold the inner deposit 514 in place until it is needed for its intended purpose, such as cleaning, keeping the spongy foam layer 512 clean and dry until the designated project begins; this layer 518 can then dissolve or become permeable upon contact with water, allowing the inner deposit 514 of the active agent to disperse throughout the spongy foam layer 512 to reach its outer surface and contact the areas that are to be treated, for example, the areas to be cleaned by a cleaning agent. The spongy foam layer 512 can be surrounded by an optional external layer of an active agent and/or abrasive material 520, which can be formed similarly to the layer of an active agent and/or abrasive material 504 shown in FIG. 5A. For example, this optional external layer 520 can comprise abrasive areas, similar to those described in FIG. 5A for the layer of abrasive material or active agent, e.g., scrubbing or cleaning material. Using the methods described above, all the components of the surface-interactive utensil 510 can be made from foams formed from simple NCE-based matrices or materials or composite NCE-containing matrices or materials. For example, manufacturing the foamed surface-interactive utensil, e.g., a cleaning utensil, can include a step of encasing a foam matrix comprising redispersed (or redispersible) NCEs in an external layer of an abrasive scrubbing material before the step of drying the foamed material to form the dried formed foamed article, e.g., a cleaning utensil, wherein the scrubbing material has different mechanical properties than the dried formed foamed article. Alternatively, manufacturing the surface-interactive utensil, e.g., a cleaning sponge or other cleaning utensil, can include a step of encasing the foamed article bearing the active agent (forming, for example, a cleaning-substance-bearing foamed article) in the abrasive material before the step of drying the foamed article to produce the cleaning utensil, wherein the scrubbing material has different properties than the cleaning-substance-bearing foamed article.

In embodiments, the surface-interactive utensil, such as a cleaning utensil, can comprise a foamed material comprising redispersed (or redispersible) NCEs (for example, shaped as a foam or a formed foamed article), and a NCE-containing active agent (e.g., a cleaning formulation) included within the cells of the foamed material or coated around the outside of the formed foamed article, or both. NCE-containing active agents (e.g., cleaning formulations) to be used in conjunction with a foam or formed foamed article include (a) a population of redispersible NCEs formulated with the dispersal additives described previously to render them redispersible; (b) a task-specific cleaning agent, such as (for cleaning articles) a soap or detergent selected for performing at least one cleaning task; and optionally: (c) a foaming agent, as described previously; (d) additives to manage water hardness (e.g., sodium citrate, chelating agents such as MGDA (methylglycine N,N-diacetic acid trisodium salt), and the like); and (e) other additives to provide advantageous properties (e.g., antimicrobial agents, substances to enhance aesthetics such as colorants and fragrances, other secondary cleaning agents such as enzymes or whitening agents, and the like). In an embodiment, the redispersible NCE component of the NCE-containing formulation (including NCEs and dispersal additives) can comprise about 10% of the NCE-containing formulation by weight; in such embodiments, the active agent (such as a task-specific soap or detergent for cleaning purposes) can comprise 60% and 70% of the NCE-containing formulation by weight, and the foaming agent can comprise about 5% of the NCE-containing formulation by weight, with the other optional additives comprising the remainder of the formulation.

Suitable foaming agents can comprise a variety of substances, as described previously. In embodiments, surfactant materials such as coco betaine, sodium laureth sulfate (SLS), and the like, can be used in preparing the foam for a variety of applications, such as cleaning applications. In embodiments, an anti-microbial agent can be added in an amount of about 0.2% of the NCE-containing formulation, although more or less can be added depending on the requirements of the specific task envisioned for the surface-interactive utensil. Neolone M10 can be used as an anti-microbial agent if desired, offering the advantages of biodegradability and compatibility with other ingredients in the formulation. Additives for managing hard water can include sodium citrate, or a chelating agent such as MGDA, or the like.

Advantageously, xylitol and HPMC can be provided as dispersal additives to be used in combination with NCEs to produce a NCE-containing formulation that is to be combined with the active agent, such as a task-specific soap or detergent, and with other additives as needed. As previously described, NCEs (rendered redispersible by the dispersal additives) act as a matrix within which the active agent and other additives are held. In an exemplary embodiment, NCEs, HPMC, and xylitol can be added in a ratio of between about 5:2:10 and about 6:1:1 (NCEs to HPMC to xylitol) to produce the NCE-based matrix, recognizing that the ratio of about 5:2:10 produces faster redispersion, while the ratio of about 6:1:1 is more cost-optimized. Additionally, a second temperature responsive polymer can be selected to further boost dispersion when quick dispersion times are required. For example, NaCMC can be added in addition to the previous formulations in a ratio of between 20:1 to 4:1 (NCEs to CMC). These ratio ranges are also applicable for other temperature responsive polymer and blocking agent. In another exemplary embodiment, NCEs, MC, and glycerol can be added in a ratio between about 5:2:10 and about 6:1:1 (NCEs to MC to glycerol). Using an LCST polymer (e.g., HPMC) as an additive allows the NCE-containing cleaning formulation to be heated above its lower critical solution temperature to dry it and form a solid. The solid material thus formed then redisperses when it comes in contact with water.

In embodiments, these properties allow a NCE-containing formulation to be applied to a foamed material (such as would be employed in a sponge or other cleaning utensil) comprising NCEs, either as a simple NCE-based matrix or as a composite NCE-containing matrix. Without being bound by theory, it is understood that the presence of the NCEs in the NCE-containing formulation imparts desirable mechanical properties to the formulation that allows it to attach to the foam cells (e.g., to coat the cell walls and/or penetrate the cell interiors) and remain attached until exposed to water during the selected task (such as a cleaning process), wherein the water redisperses the NFCs and loosens the attachment of the overall NCE-containing formulation to the material so that the formulation can participate in the designated task.

To produce the NCE-containing formulation described above, a 10% solution of the NCE component (e.g., NFCs, MFCs, or mixtures thereof) is first weighed out to the appropriate volume. The amount of water needed to dilute the 10% concentration of NCEs to a 5% concentration of NCEs is then measured. The extra water is employed to dissolve the desired amount of the dispersal additives xylitol and HPMC. This new solution, containing the appropriate amounts of xylitol and HPMC, is then mixed with the 10% solution of NCEs in water to coat the NCE fibers with these dispersal agents, resulting in the 5% aqueous solution of NCEs with the dispersal agents. Separately, a solution of additives and active agents such as cleaning agents is prepared by dissolving any desirable additives (e.g., a foaming agent or an antimicrobial agent) into the solution containing the active agents such as cleaning agents. This formulation, e.g., a cleaning formulation comprising the cleaning agent(s) and other desirable additives, is then combined with the NCE+xylitol+HPMC formulation, yielding the NCE-containing formulation such as a cleaning formulation that can be added to a formed foamed article to produce the foamed surface-interactive utensil, such as a cleaning utensil.

A completely or partially dried NFC-containing foamed article formed as described above can be dipped into, sprayed or saturated with, or otherwise exposed to the NCE-containing formulation of active agents, such as a cleaning formulation, allowing the foamed article to imbibe the NCE-containing formulation into its interior and/or to become at least partially encased in the NCE-containing formulation as an outer coating. Next, the foamed article containing the NCE-containing formulation can be lifted out of or otherwise removed from contact with the NCE-containing formulation of active agents and placed in an oven at 70° C. for about 2 to 3 hours to dry. Once dried, a surface-interactive utensil is produced comprising a NCE-containing formulation of active agents, such as a cleaning formulation that encases and/or penetrates the NCE-containing foamed article. When exposed to water, the thick layer of the dried NCE-containing cleaning formulation releases the cleaning agent from its NCE matrix to perform a designated cleaning task.

In embodiments, it can be desirable to engineer the foam article itself to optimize its functionalities for specific purposes, for example cleaning purposes. To accomplish this for a cleaning utensil, barrier properties can be introduced into the foam used for making the utensil using the techniques for rendering the formulation more hydrophobic or oleophobic, as described above. In embodiments, oil and grease resistant properties can be imparted to the foam by rendering some or all of the NCE particles more oleophobic, and/or by preparing a composite NCE-containing matrix having oleophobic properties, or by introducing oleophobic barrier-producing formulations into an appropriate NCE-based/NCE-containing matrix or material; similarly, water resistant properties can be imparted to the foam by rendering some or all of the NCE particles more hydrophobic, and/or by preparing a composite NCE-containing matrix having hydrophobic properties, or by introducing hydrophobic barrier-producing formulations into an appropriate NCE-based/NCE-containing matrix or material. As described herein, foamed formulations can be customized to emphasize either the oleophobic or hydrophobic properties, and foamed formulations can be tuned to exhibit both types of properties to greater or lesser degrees.

### EXAMPLES

### Example 1: Producing Redispersible NCE Sheets

Redispersible NCE sheets were produced by combining drying/dispersal additive with an NCE slurry and then drying it at elevated temperature in an oven. There are various combinations and multiple ratios of additives that can be used to create sheets of dried redispersible NCEs. For this specific example the LCST polymer hydroxypropyl methyl cellulose (HPMC) was used as the dispersal additive in combination with nanofibrillated cellulose (NFC) with a ratio of 5:1 NFC: HPMC. Ingredients were combined in a water solution consisting of 1.25 wt % NFC.

TABLE 1
Ingredients for creating redispersible NFC.

| 3 wt % NFC | Water | HPMC |
|---|---|---|
| 41.67 g (1.25 g dry) | 58.08 | 0.25 g |

First, 0.25 g of HPMC was added to 58.08 g of water in a beaker while stirring at a medium-high speed for about 15 minutes, following which the stir speed was decreased to its lowest setting, with mixing continued until all bubbles on the surface dissipated. After removing the beaker from the stir plate, 41.67 g of 3 wt % of Valida L NFC (1.25 g of dry weight NFC) was added. These ingredients were then mixed using an overhead stirrer at 250 rpm for 15 minutes. The fully mixed sample was then scooped onto a silicone mat and spread across the mat evenly, using a doctor blade set to 1.5 mm thickness. The mat with the sample on it was placed in an oven and dried at 60° C. until the sample was fully dried (about 2 hours). The dried sheet was slowly removed from the silicone mat. As a result of these procedures, the previously non-dispersible NFCs were modified with drying/dispersal additives so that they could be redispersed when combined with water. A dried sheet containing such redispersible NFCs was produced by these procedures.

### Example 2: Foaming Redispersed NCEs

### Materials

3% Valida L Nano Fibrillated Cellulose
Methylcellulose (MC), Sigma Aldrich
Gum Rosin, Sigma Aldrich.
Ethanol, McMaster Carr
Glycerol, Sigma Aldrich
Kraft Pulp, General.
Pentane, McMaster Carr

### Formulation Preparation

A redispersible NCE sheet was prepared using the following ratios of ingredients: 3:1 MC: NCEs and 19:1 MC: glycerol, generally following the protocol of Example 1. A 1.94 g sample of the dried redispersible NCE sheet (containing 1.4 g MC, 0.467 g of NCEs, and 0.074 grams of glycerol) was manually shredded, following which the shredded solids were resuspended in in 50 ml of water, stirring the suspension with a stir bar or overhead mixer to produce an aqueous slurry of redispersed NCEs. 4 g of kraft pulp were finely shredded in a blender and added to the aqueous slurry of the redispersed NCEs at medium to high shear. In another beaker, 4 g of gum rosin was fully dissolved in 7.5 g of ethanol. In yet another beaker, a 1:1 mixture was prepared containing 10 grams of both ethanol and pentane (20 g total). This mixture was then added to the aqueous slurry of redispersed NCEs and pulp. Finally, at high shear, the rosin ethanol mixture was slowly poured into the aqueous slurry of redispersed NCEs and pulp. The final mixture, once fully mixed, was placed on silicone sheets or in a mold, and baked in the oven at 80° C. until dry.

### Example 3: Foaming of NCEs Having Oil, Grease, and Water Resistance

### Materials

Redispersible NCEs
Methylcellulose, Sigma Aldrich
Gum Rosin, Sigma Aldrich.
Ethanol, McMaster Carr
Precipitated calcium carbonate (PCC), Sigma Aldrich
Kraft Pulp, Genera.
Pentane, McMaster Carr
4% Pulp Slurry, Dart
Capryl Glucoside
Xanthan Gum, Bob's Red Mill

### Formulation Preparation

Redispersible NCEs can be prepared substantially as described in Example 1. Methylcellulose (MC) can be combined with the redispersible NCEs in an aqueous solution using tap water, with a NCE: MC ratio 5:1 to 1:3. These ingredients can then be combined with an overhead mixer at high shear to produce a formulation comprising redispersed NCEs. Pulp from the 4% pulp solids slurry can then be added to the formulation produced in Step 1. An exemplary amount of pulp can be 100 g of the 4% solids slurry, combined with 100 g of the aqueous solution produced in Step 1. This step (Step 2) yields a formulation comprising pulp and redispersed NCEs. PCC can be added to the formulation of Step 2, for example 1.2 g; capryl glucoside can also be added, for example 0.04 g. The mixture from Step 3 can then be combined with a premixed 1:1 solution of ethanol and pentane, for example 12 g ethanol and 12 g pentane to produce the final aqueous formulation (Step 4). In a separate beaker, a nonpolar solution can be prepared (Step 5), for example by combining 20 g of ethanol and 10 g of gum rosin and stirring until fully dissolved, with the following additional ingredients added 2 g of xanthan gum, and 0.02 g of capryl glucoside gum, and 8 g pentane. The nonpolar solution from Step 5 can then be added at high shear to the final aqueous formulation from Step 4, producing a mixture for forming foamed articles (Step 6). Once fully homogenized, the mixture from Step 6 can be placed on a perforated silicone sheet or mold and baked in the oven at 80-90° C. until dry (approximately 3 hours depending on the size and thickness of the sample). It can be observed that the wet mixture can expand and dry/set in an expanded foam. This unpressed foam can be used for space-filling articles such as packing peanuts. It can also be thermoformed into formed articles of manufacture. As an example, the unpressed foam can be thermoformed at 200 C.° for 8 seconds into the shape of a bowl.

### Example 4: Water-Soluble NCE-Containing Foams

### Materials

Redispersible NCEs
Methylcellulose, Sigma Aldrich.
Ethanol, McMaster Carr
Precipitated calcium carbonate (PCC), Sigma Aldrich
Kraft Pulp, Genera.
Pentane, McMaster Carr
Capryl Glucoside
Xanthan Gum, Bob's Red Mill
Formulation Preparation

Redispersible NCEs were prepared substantially as described in Example 1. Precipitated calcium carbonate (1.2 g), Xanthan gum (2 g), Methylcellulose (3 g) was added to hot water (100 mL of 60° C. water) and combined with redispersible NCEs (4 g of dry weight of NFCs) in an aqueous solution using tap water, with the redispersible NFC sheets having a ratio of NFC:MC ratio 5:1 to 1:3 (Step 1). These ingredients were combined with an overhead mixer at high shear to produce a formulation comprising redispersed NFCs. Pulp from the 4% pulp solids slurry was then added to the formulation produced in Step 1. About 100 g of the 4% solids slurry was combined with 100 g of the aqueous solution produced in Step 1. This step (Step 2) yielded a formulation comprising pulp and redispersed NFCs. Capryl glucoside 0.04 gm was then added to the aqueous mixture (Step 3). The mixture from Step 3 was then combined with a premixed 1:1 solution of ethanol and pentane to produce the final aqueous formulation (Step 4). In this example, 8 g of both pentane and ethanol were used. The final aqueous solution was homogenized using an IKA T25 overhead homogenizer (Step 5). The final mixture from Step 5 was placed on a perforated silicone sheet or mold and baked in the oven at 60-95° C. (here, 70° C.) until dry. It can be observed that the wet mixture can expand, dry, and set in an expanded foam. This unpressed foam can be used for space-filling articles such as packing peanuts. It can also be thermoformed into formed articles of manufacture. In this Example, the unpressed foam was thermoformed at 200 C.° for 8 seconds into the shape of a bowl.

### Example 5: Foaming of NCE-Containing Laundry Cleaning Agents

### Materials

Nanofibrillated Cellulose (NFC) 30% solids Wet-Crumb, Performance BioFilaments.
Bleached Softwood Kraft Pulp (4% solid), Genera
Deionized Water
Xylitol, Now Real Food
Hydroxypropyl methylcellulose (HPMC), Tylopur SE-6 ShinEtsu
Sodium carboxymethyl cellulose (NaCMC), Sigma-Aldrich
Tide Free and Gentle Laundry Detergent.
Ethanol, McMaster Carr.
Pentane, McMaster Carr

### Formulation Preparation

1.5 g of xylitol was added to a 150 ml beaker containing 12.5 mL of deionized water. A stir bar was used to mix the solution. Once the xylitol was fully dissolved, 0.3 g of HPMC was added to the solution, 0.075 g NaCMC was added to the solution, and 0.15 g of xanthan gum was added to the solution. The solution was stirred continuously using the stir bar for fifteen additional minutes, until a homogenous solution was formed.

2.5 g of 30% solids NFC was added; optionally 18.75 g of 4% solids softwood kraft pulp could be added to the additive solution prepared above. The resulting solution was then homogenized using the IKA T25 homogenizer starting at a speed of 7000 rpm, and increasing by speed increments of two to three thousand to a maximum level of 15000 rpm as needed. During homogenization, 12 g of the Tide laundry detergent was added to the solution prepared as described above. Then, the solution was baked. Note that if a lower density is required, 1 g of ethanol can be added to the aqueous solution during homogenization, followed by 1 g of pentane. Once all selected additives are added to the solution, it is homogenized for 5 minutes, to be completely homogenized. The solution as prepared was then fed through a slot die to form sheet or brick of desired thickness. These sheets were baked at 70° C. for three hours, or until dried.

### Example 6: Foaming of NCE-Containing Toilet Bowl Cleaning Agents

### Materials

Nanofibrillated Cellulose (NFC) 30% solids Wet-Crumb, Performance BioFilaments
Deionized Water
Xylitol, Now Real Food
Hydroxypropyl methylcellulose (HPMC), Tylopur SE-6 ShinEtsu
Sodium carboxymethyl cellulose (NaCMC), Sigma-Aldrich.
Toilet Bowl Cleaner Lime and Rust Destroyer, Clorox

### Formulation Preparation

1.5 g of xylitol was added to a 150 ml beaker containing 12.5 mL of deionized water. A stir bar was used to mix the solution. Once the xylitol was fully dissolved, 0.3 g of HPMC was added to the solution. 0.075 g NaCMC was added to the solution. The solution was stirred continuously using the stir bar for fifteen additional minutes, or until a homogenous solution was formed. 2.5 g of NFC was added to the additive solution. The following solution was homogenized using the IKA T25 homogenizer starting at a speed of 7000 rpm, and increased by speed increments of two to three thousand to a maximum level of 15000 rpm as needed. The solution and 36 g of the Clorox toilet bowl cleaner were added to a 250 ml beaker and stirred using the ONilAB OS20-Pro overhead mixer with a four-pronged attachment at a speed of 800 rpm. A silicon mat was heated using a T-Shirt press at a temperature of 100° C. for seconds on each side. The silicon mat was placed on a baking sheet. The redispersible sheet was formed by pouring the Clorox-NFC solution into a rectangular mold on top of the silicon mat. The solution was spread evenly using a silicon spatula. The foamed sheet was baked at 50° C. for eight hours, or until dried.

Unless otherwise indicated, all numbers expressing reaction conditions, quantities, amounts, ranges and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention. 5

While this invention has been particularly shown and described with references to preferred embodiments thereof, it will be understood by those skilled in the art that various changes in form and details may be made therein without departing from the scope of the invention encompassed by the appended claims. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications, and references cited herein are incorporated by reference in their entirety.

1. A surface-interactive utensil comprising a foamed material, wherein the foamed material comprises a simple NCE-based matrix comprising redispersed or redispersible NCEs or a composite NCE-containing matrix comprising redispersed or redispersible NCEs;
wherein the redispersible NCEs are prepared by partially or completely drying a liquid formulation, wherein the liquid formulation comprises a suspension of nanocellulose elements (NCEs) in a liquid medium and a drying/dispersal additive;
wherein the redispersed NCEs are prepared by suspending the redispersible NCEs in a resuspending fluid; and
wherein the drying/dispersal additive is a temperature-responsive polymer, a volatile small molecule additive or a blocking agent, and wherein the drying/dispersal additive disrupts hydrogen bonding between the nanocellulose elements during the drying of the liquid formulation.

2. The surface-interactive utensil of claim 1, wherein the surface-interactive utensil further comprises an active agent and wherein the foamed material is amalgamated with the active agent.

3. The surface-interactive utensil of claim 2, wherein the foamed material is amalgamated with the active agent by a mechanism selected from the group consisting of coating a portion of the foamed material with the active agent, enveloping the active agent in the foamed material, or layering the foamed material to deploy the active agent on a layer that is interdigitated with other components of the surface-interactive utensil.

4. (canceled)

5. (canceled)

6. The surface-interactive utensil of claim 2, further comprising a durable component and a dissolvable component.

7. The surface-interactive utensil of claim 2, wherein the surface-interactive utensil is a cleaning utensil, and the active agent comprises a cleaning substance.

8. (canceled)

9. The surface-interactive utensil of claim 2, wherein the foamed material is shaped as a sponge.

10. The surface-interactive utensil of claim 2, wherein the foamed material is surrounded by a layer of the active agent or wherein the foamed material encloses an inner deposit of the active agent.

11. (canceled)

12. (canceled)

13. The surface-interactive utensil of claim 2, wherein the foamed material comprises the simple NCE-based matrix.

14. The surface-interactive utensil of claim 13, wherein the simple NCE-based matrix comprises redispersible NCEs.

15. The surface-interactive utensil of claim 2, wherein the foamed material comprises the composite NCE-containing matrix.

16. The surface-interactive utensil of claim 15, wherein the composite NCE-containing matrix comprises redispersed NCEs.

17. The surface-interactive utensil of claim 2, wherein the foamed material further comprises an external layer comprising the active agent or comprises a scrubbing material having different mechanical properties than the foamed material.

18. A surface-interactive utensil, comprising:
a surface-interactive foamed material selected from the group consisting of an absorbent material, an abrasive material, and an applicator material, and wherein the foamed material comprises an active agent;
wherein the surface-interactive foamed material further comprises a simple NCE-based matrix comprising a population of redispersed or redispersible NCEs or comprises a composite NCE-containing matrix comprising the population of redispersed or redispersible NCEs; and
wherein the active agent is included within the cells of the foamed material or coated around at least a portion of the outside of the foamed material, or both;
wherein the redispersible NCEs are prepared by partially or completely drying a liquid formulation, wherein the liquid formulation comprises a suspension of nanocellulose elements (NCEs) in a liquid medium and a drying/dispersal additive;
wherein the redispersed NCEs are prepared by suspending the redispersible NCEs in a resuspending fluid; and
wherein the drying/dispersal additive is a temperature-responsive polymer, a volatile small molecule additive or a blocking agent and wherein the drying/dispersal additive disrupts hydrogen bonding between the nanocellulose elements during the drying of the liquid formulation.

19. The surface-interactive utensil of claim 18, wherein the shape of the surface-interactive utensil is flat, curved, pointed, rectangular, cuboidal, conical, cylindrical, spherical, or toroidal, and wherein the size of the surface-interactive utensil three-dimensionally is adapted for directing the active agent to the target surface and permitting the manipulation necessary to reach the target surface and direct the active agent thereto.

20. (canceled)

21. (canceled)

22. The surface-interactive utensil of claim 18, wherein the foamed material is amalgamated with the active agent.

23. The surface-interactive utensil of claim 22, wherein the foamed material is amalgamated with the active agent by a mechanism selected from the group consisting of incorporating the active agent into its substance, coating a portion of the foamed material with the active agent, enveloping the active agent in the foamed material, or layering the foamed material to deploy the active agent on a layer that is interdigitated with other components of the surface-interactive utensil.

24. (canceled)

25. The surface-interactive utensil of claim 18, wherein the active agent is selected from the group consisting of cleaning agents for household or personal care purposes, personal care agents, pharmaceutical or medicinal or wellness-promoting agents, cosmetic agents, and agricultural or horticultural agents.

26. The surface-interactive utensil of claim 18, wherein the surface-interactive utensil is a cleaning utensil, and the active agent is a cleaning agent for household or personal care purposes.

27. The surface-interactive utensil of claim 26, wherein the cleaning agent comprises NCEs.

28. The surface-interactive utensil of claim 27, wherein the cleaning agent further comprises HPMC and xylitol in a ratio of between about 5:2:10 (NCE:HPMC:xylitol) to about 6:1:1 (NCE:HPMC:xylitol).

29. (canceled)

30. (canceled)

31. The surface-interactive utensil of claim 26, wherein the cleaning agent is combined with one or more additives to produce a cleaning formulation;
wherein the one or more additives are selected from the group consisting of a foaming agent, an additive to manage water hardness, an antimicrobial agent, a secondary cleaning substance, a colorant, and a fragrance.

32. The surface-interactive utensil of claim 18, wherein the foamed material further comprises a reinforcement agent.

33. The surface-interactive utensil of claim 32, wherein the reinforcement agent comprises NCEs.

34. The surface-interactive utensil of claim 18, wherein the foamed material further comprises a barrier formulation.

35. The surface-interactive utensil of claim 34, wherein the barrier formulation produces at least one of hydrophobicity and oleophobicity.

36. The surface-interactive utensil of claim 18, wherein the active agent is coated on at least a portion of the outside of the foamed material in layers.

37. A method of manufacturing a surface-interactive utensil, comprising:
providing a foamed material, wherein the foamed material comprises a simple NCE-based matrix comprising redispersed or redispersible NCEs or a composite NCE-containing matrix comprising redispersed or redispersible NCEs;
initially drying the foamed material to form a dried formed foamed article;
exposing the dried formed foamed article to an active agent so that the formed foamed article either imbibes the active agent into its interior or becomes at least partially encased in the active agent, thereby forming an active-agent-bearing foamed article; and
secondarily drying the active-agent-bearing foamed article to produce the surface-interactive utensil;
wherein the redispersible NCEs are prepared by partially or completely drying a liquid formulation, wherein the liquid formulation comprises a suspension of nanocellulose elements (NCEs) in a liquid medium and a drying/dispersal additive;
wherein the redispersed NCEs are prepared by suspending the redispersible NCEs in a resuspending fluid; and
wherein the drying/dispersal additive is a temperature-responsive polymer, a volatile small molecule additive or a blocking agent and wherein the drying/dispersal additive disrupts hydrogen bonding between the nanocellulose elements during the drying of the liquid formulation.

38. The method of claim 37, wherein the surface-interactive utensil is a cleaning utensil and the active agent comprises a cleaning substance.

39. The method of claim 38, wherein the cleaning substance comprises a cleaning agent or a cleaning formulation.

40. (canceled)

41. The method of claim 37, further comprising a step selected from the group consisting of: encasing the foamed material in an external layer of a scrubbing material before the step of initially drying the foamed material, wherein the scrubbing material has different mechanical properties than the dried formed foamed article wherein the scrubbing material has different mechanical properties than the dried formed foamed article; and encasing the foamed article bearing the cleaning substance in the scrubbing material before the step of secondarily drying the cleaning-substance-bearing foamed article, wherein the scrubbing material has different mechanical properties than the cleaning-substance-bearing foamed article.
